(19) United States
(12) Patent Application Publication
(10) Pub. No.: US 2008/0318125 A1
(43) Pub. Date: Dec. 25, 2008

(54) Positive Electrode for Alkaline Storage Battery and Alkaline Storage Battery

(76) Inventors: Hiroyuki Sakamoto, Aichi-ken (JP); Takao Yamamoto, Aichi-ken (JP); Kazuhiro Ohkawa, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/658,661

(22) PCT Filed: Jul. 21, 2005
(86) PCT No.: PCT/JP2005/013800

§ 371 Date: Jan. 26, 2007

(30) Foreign Application Priority Data
Jul. 27, 2004 (JP) 2004-218705
Jul. 30, 2004 (JP) 2004-224576
Sep. 6, 2004 (JP) 2004-258327

(51) Int. Cl. H01M 4/32; H01M 4/42; H01M 4/46; H01M 4/80; H01M 4/52; H01M 4/62

(52) U.S. Cl. 429/223; 429/229; 429/231.6

(57) ABSTRACT

There are provided a low-cost positive electrode for an alkaline storage battery which retains an excellent current collectivity over a long period of time and a low-cost alkaline storage battery which retains an excellent charge/discharge efficiency over a long period of time. A positive electrode for an alkaline storage battery according to the present invention has a positive electrode substrate including a resin skeleton made of a resin and having a three-dimensional network structure and a nickel coating layer made of nickel and coating the resin skeleton and also having a void portion in which a plurality of pores are coupled in three dimensions and a positive electrode active material containing nickel hydroxide particles and filled in the void portion of the positive electrode substrate. Among them, the nickel coating layer has an average thickness of not less than 0.5 μm and not more than 5 μm. The proportion of the nickel coating layer to the positive electrode substrate is not less than 30 wt % and not more than 80 wt %. The filling amount of the positive electrode active material is not less than 3 times and not more than 10 times the weight of the positive electrode substrate.

### TECHNICAL FIELD

The present invention relates to a positive electrode for an alkaline storage battery and to an alkaline storage battery.

### BACKGROUND ART

In recent years, an alkaline storage battery has drawn attention as a power source for a portable instrument or devices or also as a power source for an electric vehicle, a hybrid electric vehicle, or the like. As such an alkaline storage battery, various types have been proposed. Among them, a nickel-metal hydride secondary battery comprising: a positive electrode made of an active material primarily containing nickel hydroxide; a negative electrode containing a hydrogen absorbing alloy as a main component; and an alkaline electrolyte containing potassium hydroxide or the like has rapidly become widespread as a secondary battery having a high energy density and excellent reliability.

The positive electrodes of nickel-metal hydride secondary batteries are roughly divided into two types depending on the difference between production processes therefor, which are a sintered nickel electrode and a paste (non-sintered) nickel electrode. Of the two types, the sintered nickel electrode is produced by precipitating nickel hydroxide in extremely fine pores in a porous sintered substrate obtained by sintering nickel fine powder onto the both sides of a punched steel plate (punching metal) by a solution impregnation method or the like. On the other hand, the paste nickel electrode is produced by filling an active material containing nickel hydroxide directly into fine pores in a high-porosity substrate using a foamed nickel porous body (formed nickel substrate). Since the paste nickel electrode is high in the filling density of nickel hydroxide and easy to be increased in energy density, it has currently become the main stream of a positive electrode for a nickel-metal hydride storage battery (see, e.g., Patent Document 1).

Patent Document 1: Jpn. unexamined patent publication No. 62 (1987)-15769

Patent Document 2: Japanese unexamined patent publication No. 2001-313038

Patent Document 3: Japanese unexamined patent publication No. 8 (1996)-321303

The foamed nickel substrate used for the paste nickel electrode is produced by plating a resin skeleton of a foamed polyurethane sheet with nickel and then burning off the resin skeleton. By such a method, it becomes possible to obtain the nickel substrate with a high void ratio and increase the filling density of nickel hydroxide, but the problem of high manufacturing cost exists because the step of burning off the resin skeleton is necessary. In addition, since the strength of the foamed nickel substrate is low, there is the undesirable possibility that repeated charging and discharging may cause the significant expansion of a nickel electrode (positive electrode) and the deformation thereof. Specifically, nickel hydroxide contained in the active material tends to suffer a change in the crystal structure thereof through charging and discharging and greatly expand. When nickel hydroxide particles have greatly expanded through charging and discharging, the foamed nickel substrate is greatly enlarged forcibly thereby so that the nickel electrode also expands greatly. The significant expansion and deformation of the nickel electrode compresses a separator and resultantly reduces the electrolyte in the separator. This may cause an increase in internal resistance and the lowering of a charge/discharge efficiency.

### DISCLOSURE OF THE INVENTION

### Problems to be Solved by the Invention

To solve such problems, there have been proposed in recent years a positive electrode substrate for an alkaline storage battery (current collecting member) produced without burning off a resin skeleton such as a non-woven fabric by plating it with nickel and a positive electrode using the positive electrode substrate (see Patent Documents 2 and 3).

In Patent Document 2, it is disclosed that, by performing a hydrophilic treatment with respect a non-woven fabric and then plating it with nickel, the adhesion of the nickel plate is improved. It is also stated that the nickel plate is preferably formed by forming an electroless nickel plating film by an electroless plating method and then further forming an electrolytic nickel plating film on the surface thereof by an electroplating method. As a result, a positive electrode substrate having a high current collectivity can be obtained. However, as a result of an examination made by the present inventors, it has been proved that, to hold the current collectivity of the positive electrode substrate excellent over a long period of time, various values including an amount of the nickel plate should be adjusted to a proper range. In addition, the high-rate discharge characteristic has lowered more significantly than that of a conventional alkaline storage battery using a foamed nickel substrate.

In Patent Document 3, it is described that a positive electrode excellent in strength characteristic can be obtained by performing a confounding treatment and a thermal treatment with respect to a non-woven fabric, plating it with nickel to form a current collector (positive electrode substrate), filling an active material in the positive electrode substrate and drying it, and then performing rolling to produce the positive electrode. It is further disclosed that, by reducing the proportion of the non-woven fabric to the positive electrode substrate (current collecting member) to 3 to 10 wt % (in other words, by increasing the proportion of the nickel plate to 90 to 97 wt %), it becomes possible to hold the void ratio of the positive electrode substrate high, thereby increase the filling density of the active material, and provide a high-capacity battery.

According to an examination made by the present inventors, in each of the alkaline storage batteries (in each of which the proportion of the non-woven fabric to the positive electrode substrate was adjusted to 3 to 10 wt %) of Patent Document 3, the current collectivity of the positive electrode substrate greatly lowered as a result of repeated charging and discharging and, consequently, the charge/discharge efficiency of the battery greatly lowered. As a result of examining the insides of the batteries, there was a battery in which a part of the nickel plating layer of the current collector (positive electrode substrate) was delaminated. There was also a battery in which a crack was observed in the nickel plating layer of the current collector (positive electrode substrate). This may be a conceivable cause of the greatly lowered charge/discharge efficiency.

The present invention has been achieved in view of such a present situation and it is therefore an object of the present invention to provide a low-cost positive electrode for an alkaline storage battery which retains an excellent current collectivity over a long period of time and a low-cost alkaline storage battery which retains an excellent charge/discharge efficiency over a long period of time. A further object of the present invention is to provide a low-cost positive electrode for an alkaline storage battery which allows improvements in the high-rate discharge characteristic and cycle lifetime characteristic of the battery and a low-cost alkaline storage battery which is excellent in high-rate discharge characteristic and also in cycle lifetime characteristic.

### Means for Solving the Problems

(1) The means for solving the problems is a positive electrode for an alkaline storage battery, the positive electrode comprising: a positive electrode substrate comprising a resin skeleton made of a resin and having a three-dimensional network structure and a nickel coating layer made of nickel and coating the resin skeleton, the positive electrode substrate having a void portion in which a plurality of pores are coupled in three dimensions; and a positive electrode active material containing nickel hydroxide particles and filled in the void portion of the positive electrode substrate, wherein an average thickness of the nickel coating layer is not less than 0.5 μm and not more than 5 μm, a proportion of the nickel coating layer to the positive electrode substrate is not less than 30 wt % and not more than 80 wt %, and a filling amount of the positive electrode active material is not less than 3 times and not more than 10 times a weight of the positive electrode substrate.

The positive electrode for an alkaline storage battery according to the present invention uses the positive electrode substrate having the resin skeleton and the nickel coating layer coating the resin skeleton. Thus, in the positive electrode for an alkaline storage battery according to the present invention, the resin skeleton that has been burned off conventionally is left in the substrate. The arrangement allows the omission of the labor of burning off the resin skeleton and thereby allows a reduction in cost.

By leaving the resin skeleton, the positive electrode substrate can be solidified. In a conventional case where foamed nickel is used as a positive electrode substrate, the positive electrode substrate may be deformed occasionally through expansion resulting from repeated charging and discharging due to the low strength of a foamed nickel skeleton. By contrast, the positive electrode for an alkaline storage battery according to the present invention is solid owing to the resin skeleton left therein and hence the expansive deformation resulting from repeated charging and discharging can be suppressed. This allows the elongation of the lifetime of the positive electrode for an alkaline storage battery.

Conventionally, the resin skeleton of foamed polyurethane or the like has been burned off since the remaining resin skeleton of foamed polyurethane or the like lowers battery characteristics such as a charge/discharge characteristic. In accordance with the present invention, however, characteristics which are proper as those of a positive electrode for an alkaline storage battery are obtainable by making the following adjustments even when the resin skeleton is left in the substrate.

Specifically, in a positive electrode substrate having a resin skeleton, a nickel coating layer coating a resin serving as the skeleton may undesirably be delaminated by repeated charging and discharging since the physical properties (such as elongation percentage and strength) of the resin greatly differ from those of the nickel coating layer coating the resin. By contrast, in the positive electrode for an alkaline storage battery according to the present invention, the average thickness of the nickel coating layer is adjusted to be not more than 5 μm. As a result of an examination made by the present inventors, it has been proved that, by adjusting the average thickness of the nickel coating layer to a value of not more than 5 μm, the adhesion between the resin and the nickel coating layer is improved and the delamination of the nickel coating layer can be suppressed over a long period of time. By thus adjusting the average thickness of the nickel coating layer to a value of not more than 5 μm, the positive electrode substrate is allowed to retain an excellent current collectivity over a long period of time.

In a conventional positive electrode using a foamed nickel substrate, the average thickness of the nickel skeleton has been adjusted to be larger than 5 μm such that the substrate has a sufficient strength to be used as a current collecting substrate. By contrast, in the positive electrode for an alkaline storage battery according to the present invention, the average thickness of the nickel coating layer of the positive electrode substrate can be adjusted to be not more than 5 μm. This allows a reduction in the amount of nickel compared with that in the positive electrode using the foamed nickel substrate and thereby allows a reduction in cost.

The thickness of the nickel coating layer is preferably minimized because the cost can be reduced more as the nickel coating layer is thinner. However, when the nickel coating layer is excessively thinned, the current collectivity of the positive electrode substrate is lowered greatly. To prevent this, in the positive electrode for an alkaline storage battery according to the present invention, the average thickness of the nickel coating layer is adjusted to be not less than 0.5 μm. The arrangement allows the positive electrode substrate to retain a necessary current collectivity and enables proper charging and discharging.

In the positive electrode for an alkaline storage battery according to the present invention, the positive electrode substrate has the resin skeleton. Accordingly, even when the average thickness of the nickel coating layer is adjusted to be not less than 0.5 μm and not more than 5 μm as described above, the intrinsic electric resistance of the positive electrode substrate increases undesirably when the proportion of the resin skeleton to the positive electrode substrate is excessively increased. As a result, the current collectivity of the positive electrode substrate suffers a significant reduction and consequently the charge/discharge efficiency of the battery may undesirably lower. To prevent this, in the positive electrode for an alkaline storage battery according to the present invention, the proportion of the nickel coating layer to the positive electrode substrate is adjusted to be not less than 30 wt % and not more than 80 wt % (or, in other words, the proportion of the resin skeleton is adjusted to be not less than 20 wt % and not more than 70 wt %). By adjusting the proportion of the nickel coating layer to the positive electrode substrate to a value of not less than 30 wt %, the electric resistance of the positive electrode substrate can be reduced and the current collectivity thereof can be improved.

The proportion of the nickel coating layer to the positive electrode substrate is preferably maximized because the electric resistance can be lowered as the proportion of the nickel coating layer to the positive electrode substrate is higher. However, an increase in the proportion of nickel is synonymous to a reduction in the proportion of the resin skeleton (the thinning of the resin skeleton). Accordingly, when the proportion of the nickel coating layer to the positive electrode substrate is excessively increased (specifically, over 80 wt %), the intrinsic strength of the positive electrode substrate greatly lowers. As a result, a problem such as a crack formed in the nickel coating layer occurs and the current collectivity may be reduced significantly thereby. To prevent this, in the positive electrode for an alkaline storage battery according to the present invention, the proportion of the nickel coating layer to the positive electrode substrate is limited to 80 wt % or less. As a result, the current collectivity can be improved without the possibility of causing a problem such as a crack formed in the nickel coating layer.

As described above, by adjusting the average thickness of the nickel coating layer to a value of not less than 0.5 μm and not more than 5 μm and adjusting the proportion of the nickel coating layer to the positive electrode substrate to a value of not less than 30 wt % and not more than 80 wt %, the positive electrode substrate is allowed to retain an excellent current collectivity over a long period of time. By using the positive electrode substrate (positive electrode), it becomes possible to further improve the charge/discharge efficiency of the battery.

Moreover, in the positive electrode for an alkaline storage battery according to the present invention, the filling amount of the positive electrode active material is adjusted to be not less than 3 times and not more than 10 times the weight of the positive electrode substrate. By adjusting the filling amount of the active material to a value of not less than 3 times the weight of the positive electrode substrate, the energy density can be increased. Accordingly, by using the positive electrode for an alkaline storage battery according to the present invention, it becomes possible to provide a high-capacity alkaline storage battery. Since the weight of the positive electrode substrate is reduced to a value of not more than ⅓ the weight of the active material, the use of the positive electrode for an alkaline storage battery is also preferred in terms of allowing reductions in the respective weights of the positive electrode and the battery.

The filling amount of the active material is preferably maximized because the energy density is higher and the capacity of the battery can be increased more as the filling amount of the active material is larger. However, as a result of an examination made by the present inventors, it has been proved that, when the filling amount of the active material is increased to be larger than 10 times the weight of the positive electrode substrate, the proportion of nickel (the nickel plate coating the resin skeleton) to the active material excessively lowers. Accordingly, the current collectivity greatly lowers and the charge/discharge efficiency (active-material utilization ratio) of the battery also greatly lowers. To prevent this, in the positive electrode for an alkaline storage battery according to the present invention, the filling amount of the active material is adjusted to be not more than 10 times the weight of the positive electrode substrate. The arrangement allows an improvement in current collectivity and also allows an improvement in the charge/discharge efficiency (active-material utilization ratio) of the battery.

(2) Further, in the aforementioned positive electrode for an alkaline storage battery, preferably, the resin skeleton is any of a foamed resin, a non-woven fabric, and a woven fabric.

Each of the foamed resin, the non-woven fabric, and the woven fabric has a three-dimensional network structure and has a void portion in which a plurality of pores are coupled in three dimensions. In addition, the size (pore diameter) of the void portion can be adjusted to a specified size relatively easily. Accordingly, by using any of the foamed resin, the non-woven fabric, and the woven fabric as the resin skeleton, it becomes possible to properly fill the specified amount of the positive electrode material. Among them, the non-woven fabric and the woven fabric are particularly preferred since the size (pore diameter) of the void portion can be freely adjusted by adjusting the thicknesses and number of fibers thereof and therefore the size (pore diameter) of the void portion can be adjusted easily.

(3) Further, in any one of the aforementioned positive electrodes for an alkaline storage battery, preferably, the resin skeleton is made of at least one resin selected from the group consisting of polypropylene, polyethylene, polyvinyl alcohol, polyester, nylon, polymethyl pentene, polystyrene, and polytetrafluoroethylene.

As stated previously, in the positive electrode for an alkaline storage battery according to the present invention, the resin skeleton is coated with the nickel coating layer so that the possibility of the exposure of the resin skeleton is low. However, in the case where a plurality of positive electrode substrates are manufactured by cutting a large substrate, there is the possibility that the resin skeleton is exposed from a cut surface. In the case where the positive electrode (positive electrode substrate) with the exposed resin skeleton is used in an alkaline storage battery, the electrolyte comes in contact with the resin skeleton so that alkali resistance is required of the resin skeleton.

By contrast, in the positive electrode for an alkaline storage battery according to the present invention, the resin skeleton of the positive electrode substrate is formed from at least one resin selected from polypropylene, polyethylene, polyvinyl alcohol, polyester, nylon, polymethyl pentene, polystyrene, and polytetrafluoroethylene. Since these resins are excellent in alkali resistance, even when the resin skeleton is exposed, it is free from the influence of the alkaline electrolyte. Consequently, the positive electrode for an alkaline storage battery according to the present invention has no possibility of suffering a problem such as the lowering of the strength under the influence of the alkaline electrolyte.

The resin skeleton may be formed from only one of the resins listed above or formed by mixing two or more resins (e.g., by producing a non-woven fabric from two or more different fibers).

(4) Further, in any one of the aforementioned positive electrodes for an alkaline storage battery, preferably, an average pore diameter of the plurality of pores forming the void portion of the positive electrode substrate is not less than 15 μm and not more than 450 μm.

In the alkaline storage battery, the current collectivity is higher as the contact area between the positive electrode active material and the nickel coating layer is larger so that the charge/discharge efficiency (active-material utilization ratio) is more excellent. Accordingly, as the pore diameters of pores forming the void portion of the positive electrode substrate are smaller, the positive electrode active material and the nickel coating layer are closer so that the contact area therebetween is larger. As a result, the current collectivity is improved so that the charge/discharge efficiency (active-material utilization ratio) of the battery is improved conceivably. Conversely, it is considered that, as the pore diameters of the pores forming the void portion of the positive electrode substrate are increased, the current collectivity lowers and the charge/discharge efficiency (active-material utilization ratio) of the battery lowers. As a result of an examination made by the present inventors, it has been proved that, when the average pore diameter is increased to be larger than 450 μm, the current collectivity lowers and the charge/discharge efficiency (active-material utilization ratio) of the battery greatly lowers.

To prevent this, in the positive electrode for an alkaline storage battery according to the present invention, the average pore diameter of the plurality of pores forming the void portion of the positive electrode substrate is adjusted to be not less than 15 μm and not more than 450 μm. By adjusting the average pore diameter to a value of not more than 450 μm, the current collectivity is improved and consequently the charge/discharge efficiency (active-material utilization ratio) of the battery can be improved. Since the average particle diameter of a commonly used positive electrode active material is about 10 μm, the positive electrode active material can be placed properly in the void portion by adjusting the average pore diameter in the void portion of the positive electrode substrate to a value of not less than 15 μm.

The average pore diameter of the plurality of pores forming the void portion can be calculated based on a pore diameter distribution measured by using, e.g., a mercury porosimeter.

(5) Further, in any one of the aforementioned positive electrodes for an alkaline storage battery, preferably, the positive electrode active material contains at least either of zinc and magnesium in a solid solution state in each of the nickel hydroxide particles.

In the positive electrode for an alkaline storage battery according to the present invention, the positive electrode substrate has a resin skeleton. In such a positive electrode substrate, the physical properties (such as elongation percentage and strength) of a resin forming the skeleton greatly differ from those of the nickel coating layer coating the resin. Accordingly, there is the possibility that the expansion/contraction of the positive electrode substrate may cause a crack in the nickel coating layer or the delamination of the nickel coating layer. To circumvent such problems, therefore, the expansion/contraction of the positive electrode substrate is preferably suppressed maximally.

It is to be noted that a crystal of nickel hydroxide tends to suffer a change in the crystal structure thereof through charging and discharging and greatly expand. When nickel hydroxide particles contained in the positive electrode active material filled in the void portion of the positive electrode substrate greatly expand through charging and discharging, the positive electrode substrate is enlarged forcibly thereby to greatly expand. As a result, there are cases where a crack is formed in the nickel coating layer of the positive electrode substrate and where the nickel coating layer delaminates as described above.

By contrast, in the positive electrode for an alkaline storage battery according to the present invention, the positive electrode active material contains at least either of zinc and magnesium in a solid solution state in each of the nickel hydroxide particles. By causing zinc and magnesium to be contained in a solid solution state in the nickel hydroxide crystal, a change in the crystal structure resulting from charging and discharging can be suppressed and the expansion of the crystal resulting from charging and discharging can also be suppressed. This can suppress the expansion of the positive electrode substrate resulting from charging and discharging and reduce the possibility of the occurrence of a crack or delamination in the nickel coating layer.

(6) Further, in any one of the aforementioned positive electrodes for an alkaline storage battery, preferably, the nickel coating layer is formed on a surface of the resin skeleton by any of an electroplating method, an electroless plating method, and a vapor deposition method.

In the positive electrode for an alkaline storage battery according to the present invention, the nickel coating layer is formed on the surface of the resin skeleton by any of an electroplating method, an electroless plating method, and a vapor deposition method. The nickel coating layer formed by any of the methods listed above can uniformly coat the surface of the resin skeleton. This allows an improvement in current collectivity and also allows an improvement in the charge/discharge efficiency (active-material utilization ratio) of the battery.

(7) Another solving means is an alkaline storage battery having any one of the aforementioned positive electrodes for an alkaline storage battery.

The alkaline storage battery according to the present invention has any of the positive electrodes described above. That is, since the alkaline storage battery according to the present invention uses the positive electrode substrate having the resin skeleton, the positive electrode substrate and also the positive electrode are solidified. As a result, the durability of the positive electrode (positive electrode substrate) is improved and hence the lifetime of the alkaline storage battery can be improved. Since the labor of burning off the resin skeleton can be omitted, the cost is reduced.

In addition, in the positive electrode substrate, the average thickness of the nickel coating layer is adjusted to be not less than 0.5 μm and not more than 5 μm and the proportion of the nickel coating layer to the positive electrode substrate is adjusted to be not less than 30 wt % and not more than 80 wt %. This allows the positive electrode to retain an excellent current collectivity over a long period of time and allows the battery to retain an excellent charge/discharge efficiency over a long period of time.

(8) Another solving means is a positive electrode for an alkaline storage battery, the positive electrode comprising: a positive electrode substrate comprising a resin skeleton made of a resin and having a three-dimensional network structure and a nickel coating layer made of nickel and coating the resin skeleton, the positive electrode substrate having a void portion in which a plurality of pores are coupled in three dimensions; and a positive electrode active material containing nickel hydroxide particles and filled in the void portion of the positive electrode substrate, wherein an average thickness of the nickel coating layer is not less than 0.5 μm and not more than 5 μm and in addition to the positive electrode active material, at least either of metal cobalt and cobalt oxyhydroxide having a γ-type crystal structure is contained in the void portion of the positive electrode substrate.

The positive electrode for an alkaline storage battery according to the present invention uses the positive electrode substrate having the resin skeleton and the nickel coating layer coating the resin skeleton. Thus, in the positive electrode for an alkaline storage battery according to the present invention, the resin skeleton that has been burned off conventionally is left in the substrate. The arrangement allows the omission of the labor of burning off the resin skeleton and thereby allows a reduction in cost.

By leaving the resin skeleton, the positive electrode substrate can be solidified. Accordingly, the expansive deformation resulting from repeated charging and discharging can be suppressed. This allows the elongation of the lifetime of the positive electrode for an alkaline storage battery.

Conventionally, as mentioned above, the resin skeleton of foamed polyurethane or the like has been burned off since the remaining resin skeleton of foamed polyurethane or the like lowers battery characteristics such as a charge/discharge characteristic. In accordance with the present invention, however, characteristics which are proper as those of a positive electrode for an alkaline storage battery are obtainable by making the following adjustments even when the resin skeleton is left in the substrate.

Specifically, in a positive electrode substrate having a resin skeleton, a nickel coating layer coating a resin serving as the skeleton may undesirably be delaminated by repeated charging and discharging since the physical properties (such as elongation percentage and strength) of the resin greatly differ from those of the nickel coating layer coating the resin. By contrast, in the positive electrode for an alkaline storage battery according to the present invention, the average thickness of the nickel coating layer is adjusted to be not more than 5 μm. As a result of an examination made by the present inventors, it has been proved that, by adjusting the average thickness of the nickel coating layer to a value of not more than 5 μm, the adhesion between the resin and the nickel coating layer is improved and the delamination of the nickel coating layer can be suppressed over a long period of time. By thus adjusting the average thickness of the nickel coating layer to a value of not more than 5 μm, the positive electrode substrate is allowed to retain an excellent current collectivity over a long period of time.

In a conventional positive electrode using a foamed nickel substrate, the average thickness of the nickel skeleton has been adjusted to be larger than 5 μm such that the substrate has a sufficient strength to be used as a current collecting substrate. By contrast, in the positive electrode for an alkaline storage battery according to the present invention, the average thickness of the nickel coating layer of the positive electrode substrate can be adjusted to be not more than 5 μm. This allows a reduction in the amount of nickel compared with that in the positive electrode using the foamed nickel substrate and thereby allows a reduction in cost.

Accordingly, by adjusting the average thickness of the nickel coating layer to a value of not less than 0.5 μm and not more than 5 μm, the cycle lifetime characteristic of the battery can be improved.

In the case where the resin skeleton is left in the positive electrode substrate and the average thickness of the nickel coating layer of the positive electrode substrate is reduced to 5 μm or less as in the positive electrode for an alkaline storage battery according to the present invention, the electric resistance of the positive electrode substrate tends to be higher than that of the conventional foamed nickel substrate. As a result, there is the possibility that the high-rate discharge characteristic of the battery particularly lowers compared with the case where the conventional foamed nickel substrate is used.

By contrast, in the positive electrode for an alkaline storage battery according to the present invention, at least either of metal cobalt and cobalt oxyhydroxide having a γ-type crystal structure is contained in addition to the positive electrode active material. Since each of metal cobalt and cobalt oxyhydroxide having a γ-type crystal structure is high in conductivity, a network with an excellent conductivity can be formed and the high-rate discharge characteristic can be improved by causing metal cobalt and cobalt oxyhydroxide having a γ-type crystal structure to be contained.

(9) Furthermore, in the aforementioned positive electrode for an alkaline storage battery, preferably, a proportion of the nickel coating layer to the positive electrode substrate is not less than 30 wt % and not more than 80 wt %.

In the positive electrode substrate having a resin skeleton, as mentioned above, even when the average thickness of the nickel coating layer is adjusted to be not less than 0.5 μm and not more than 5 μm as described above, the intrinsic electric resistance of the positive electrode substrate increases undesirably when the proportion of the resin skeleton to the positive electrode substrate is excessively increased. As a result, the current collectivity of the positive electrode substrate suffers a significant reduction and consequently the charge/discharge efficiency of the battery may undesirably lower. To prevent this, in the positive electrode for an alkaline storage battery according to the present invention, the proportion of the nickel coating layer to the positive electrode substrate is adjusted to be not less than 30 wt % and not more than 80 wt % (or, in other words, the proportion of the resin skeleton is adjusted to be not less than 20 wt % and not more than 70 wt %). By adjusting the proportion of the nickel coating layer to the positive electrode substrate to a value of not less than 30 wt %, the electric resistance of the positive electrode substrate can be reduced and the current collectivity thereof can be improved.

The proportion of the nickel coating layer to the positive electrode substrate is preferably maximized because the electric resistance can be lowered as the proportion of the nickel coating layer to the positive electrode substrate is higher. However, an increase in the proportion of nickel is synonymous to a reduction in the proportion of the resin skeleton (the thinning of the resin skeleton). Accordingly, when the proportion of the nickel coating layer to the positive electrode substrate is excessively increased (specifically, over 80 wt %), the intrinsic strength of the positive electrode substrate greatly lowers. As a result, a problem such as a crack formed in the nickel coating layer occurs and the current collectivity may be reduced significantly thereby. To prevent this, in the positive electrode for an alkaline storage battery according to the present invention, the proportion of the nickel coating layer to the positive electrode substrate is limited to 80 wt % or less. As a result, the current collectivity can be improved without the possibility of causing a problem such as a crack formed in the nickel coating layer.

(10) Further, in any one of the aforementioned positive electrodes for an alkaline storage battery, preferably, the resin skeleton is any of a foamed resin, a non-woven fabric, and a woven fabric.

Each of the foamed resin, the non-woven fabric, and the woven fabric has a three-dimensional network structure and has a void portion in which a plurality of pores are coupled in three dimensions. In addition, the size (pore diameter) of the void portion can be adjusted to a specified size relatively easily. Accordingly, by using any of the foamed resin, the non-woven fabric, and the woven fabric as the resin skeleton, it becomes possible to properly fill the specified amount of the positive electrode material. Among them, the non-woven fabric and the woven fabric are particularly preferred since the size (pore diameter) of the void portion can be freely adjusted by adjusting the thicknesses and number of fibers thereof and therefore the size (pore diameter) of the void portion can be adjusted easily.

(11) Further, in any one of the aforementioned positive electrodes for an alkaline storage battery, preferably, the resin skeleton is made of at least one resin selected from the group consisting of polypropylene, polyethylene, polyvinyl alcohol, polyester, nylon, polymethyl pentene, polystyrene, and polytetrafluoroethylene.

As stated previously, in the positive electrode for an alkaline storage battery according to the present invention, the resin skeleton is coated with the nickel coating layer so that the possibility of the exposure of the resin skeleton is low. However, in the case where a plurality of positive electrode substrates are manufactured by cutting a large substrate, there is the possibility that the resin skeleton is exposed from a cut surface. In the case where the positive electrode (positive electrode substrate) with the exposed resin skeleton is used in an alkaline storage battery, the electrolyte comes in contact with the resin skeleton so that alkali resistance is required of the resin skeleton.

By contrast, in the positive electrode for an alkaline storage battery according to the present invention, the resin skeleton of the positive electrode substrate is formed from at least one resin selected from polypropylene, polyethylene, polyvinyl alcohol, polyester, nylon, polymethyl pentene, polystyrene, and polytetrafluoroethylene. Since these resins are excellent in alkali resistance, even when the resin skeleton is exposed, it is free from the influence of the alkaline electrolyte. Consequently, the positive electrode for an alkaline storage battery according to the present invention has no possibility of suffering a problem such as the lowering of the strength under the influence of the alkaline electrolyte.

The resin skeleton may be formed from only one of the resins listed above or formed by mixing two or more resins (e.g., by producing a non-woven fabric from two or more different fibers).

(12) Further, in any one of the aforementioned positive electrodes for an alkaline storage battery, preferably, at least either of the metal cobalt and the cobalt oxyhydroxide having a 7-type crystal structure is contained at a ratio of 2 to 10 parts by weight to 100 parts by weight of the positive electrode active material.

In the positive electrode for an alkaline storage battery according to the present invention, at least either of metal cobalt and cobalt oxyhydroxide having a 7-type crystal structure is caused to be contained at a ratio of 2 to 10 parts by weight to 100 parts by weight of the positive electrode active material. By causing at least either of metal cobalt and cobalt oxyhydroxide having a 7-type crystal structure to be contained at a ratio of not less than 2 parts by weight to 100 parts by weight of the positive electrode active material, an excellent current collectivity can be obtained and therefore the utilization ratio of the positive electrode active material during high-rate discharging can also be improved. By limiting the ratio to 10 parts by weight or less, it becomes possible to suppress a reduction in the filling amount of the positive electrode active material (nickel hydroxide) and suppress a reduction in the energy density of the positive electrode.

(13) Further, in any one of the aforementioned positive electrodes for an alkaline storage battery, preferably, a surface of the positive electrode active material is coated with the cobalt oxyhydroxide having a 7-type crystal structure.

In the positive electrode for an alkaline storage battery according to the present invention, the surface of the positive electrode active material is coated with cobalt oxyhydroxide having a γ-type crystal structure. This allows cobalt oxyhydroxide having a γ-type crystal structure to be uniformly distributed within the positive electrode. As a result, the current collectivity is further improved and the high-rate discharge characteristic of the battery can further be improved.

(14) Further, in any one of the aforementioned positive electrodes for an alkaline storage battery, preferably, the positive electrode active material contains at least either of zinc and magnesium in a solid solution state in each of the nickel hydroxide particles.

In the positive electrode for an alkaline storage battery according to the present invention, the positive electrode substrate has a resin skeleton. In such a positive electrode substrate, the physical properties (such as elongation percentage and strength) of a resin forming the skeleton greatly differ from those of the nickel coating layer coating the resin. Accordingly, there is the possibility that the expansion/contraction of the positive electrode substrate may cause a crack in the nickel coating layer or the delamination of the nickel coating layer. To circumvent such problems, therefore, the expansion/contraction of the positive electrode substrate is preferably suppressed maximally.

It is to be noted that a crystal of nickel hydroxide tends to suffer a change in the crystal structure thereof through charging and discharging and greatly expand. When nickel hydroxide particles contained in the positive electrode active material filled in the void portion of the positive electrode substrate greatly expand through charging and discharging, the positive electrode substrate is enlarged forcibly thereby to greatly expand. As a result, there are cases where a crack is formed in the nickel coating layer of the positive electrode substrate and where the nickel coating layer delaminates as described above.

By contrast, in the positive electrode for an alkaline storage battery according to the present invention, the positive electrode active material contains at least either of zinc and magnesium in a solid solution state in each of the nickel hydroxide particles. By causing zinc and magnesium to be contained in a solid solution state in the nickel hydroxide crystal, a change in the crystal structure resulting from charging and discharging can be suppressed and the expansion of the crystal resulting from charging and discharging can also be suppressed. This can suppress the expansion of the positive electrode substrate resulting from charging and discharging and reduce the possibility of the occurrence of a crack or delamination in the nickel coating layer.

(15) Further, in any one of the aforementioned positive electrodes for an alkaline storage battery, preferably, in addition to the positive electrode active material, at least either of yttrium oxide and zinc oxide is contained in the void portion of the positive electrode substrate.

In the positive electrode for an alkaline storage battery, an oxygen-generating reaction proceeds as a secondary reaction during the final period of charging. It is known that, since the oxygen-generating reaction proceeds particularly readily in a high-temperature state, the reaction of nickel hydroxide as a primary reaction is inhibited thereby and the resulting lowering of the active-material utilization ratio causes a reduction in charge efficiency. As a result of an examination made by the present inventors, it has been proved that, in the case where the positive electrode substrate having the resin skeleton is used, the charge efficiency of the battery in a high-temperature state slightly lowers compared with the case where the foamed nickel substrate is used.

To prevent this, in the positive electrode for an alkaline storage battery according to the present invention, at least either of yttrium oxide and zinc oxide is contained in addition to the positive electrode active material. As a result, an oxygen overvoltage can be increased so that it becomes possible to suppress the oxygen-generating reaction during the final period of charging and improve the charge efficiency even in a high-temperature state.

Preferably, both of yttrium oxide and zinc oxide are contained since the arrangement can further increase the oxygen overvoltage and provide an excellent charge efficiency.

(16) Further, in any one of the aforementioned positive electrodes for an alkaline storage battery, preferably, the nickel coating layer is formed on a surface of the resin skeleton by any of an electroplating method, an electroless plating method, and a vapor deposition method.

In the positive electrode for an alkaline storage battery according to the present invention, the nickel coating layer is formed on the surface of the resin skeleton by any of an electroplating method, an electroless plating method, and a vapor deposition method. The nickel coating layer formed by any of the methods listed above can uniformly coat the surface of the resin skeleton. This allows an improvement in current collectivity and also allows an improvement in the charge/discharge efficiency (active-material utilization ratio) of the battery.

(17) Another solving means is an alkaline storage battery having any of the positive electrodes for an alkaline storage battery described above.

The alkaline storage battery according to the present invention has any of the positive electrodes described above. That is, since the alkaline storage battery according to the present invention uses the positive electrode substrate having the resin skeleton, the positive electrode substrate and also the positive electrode are solidified. As a result, the durability of the positive electrode (positive electrode substrate) is improved and hence the lifetime of the alkaline storage battery can be improved. Since the labor of burning off the resin skeleton can be omitted, the cost is reduced.

In addition, in the positive electrode substrate, the average thickness of the nickel coating layer is adjusted to be not less than 0.5 μm and not more than 5 μm. The arrangement allows the delamination of the nickel coating layer to be suppressed over a long period of time and thereby allows proper charging and discharging to be performed over a long period of time. In other words, the arrangement allows an improvement in the cycle lifetime characteristic of the battery. Moreover, at least either of metal cobalt and cobalt oxyhydroxide having a γ-type crystal structure is contained in the positive electrode in addition to the positive electrode active material. By causing metal cobalt and cobalt oxyhydroxide having a γ-type crystal structure to be contained, a network with an excellent conductivity can be formed and the high-rate discharge characteristic can be improved.

(18) Another solving means is a positive electrode for an alkaline storage battery, the positive electrode comprising: a positive electrode substrate comprising a resin skeleton made of a resin and having a three-dimensional network structure and a nickel coating layer made of nickel and coating the resin skeleton, the positive electrode substrate having a void portion in which a plurality of pores are coupled in three dimensions; and a positive electrode active material containing nickel hydroxide particles and filled in the void portion of the positive electrode substrate, wherein an average thickness of the nickel coating layer is not less than 0.5 μm and not more than 5 μm and in addition to the positive electrode active material, at least either of metal cobalt and cobalt oxyhydroxide having a β-type crystal structure is contained in the void portion of the positive electrode substrate.

The positive electrode for an alkaline storage battery according to the present invention uses the positive electrode substrate having the resin skeleton and the nickel coating layer coating the resin skeleton. Thus, in the positive electrode for an alkaline storage battery according to the present invention, the resin skeleton that has been burned off conventionally is left in the substrate. The arrangement allows the omission of the labor of burning off the resin skeleton and thereby allows a reduction in cost.

By leaving the resin skeleton, furthermore, the positive electrode substrate can be solidified. In a conventional case where foamed nickel is used as a positive electrode substrate, the positive electrode substrate may be deformed occasionally through expansion resulting from repeated charging and discharging due to the low strength of a foamed nickel skeleton. By contrast, the positive electrode for an alkaline storage battery according to the present invention is solid owing to the resin skeleton left therein and hence the expansive deformation resulting from repeated charging and discharging can be suppressed. This allows the elongation of the lifetime of the positive electrode for an alkaline storage battery.

Conventionally, the resin skeleton of foamed polyurethane or the like has been burned off since the remaining resin skeleton of foamed polyurethane or the like lowers battery characteristics such as a charge/discharge characteristic. In accordance with the present invention, however, characteristics which are proper as those of a positive electrode for an alkaline storage battery are obtainable by making the following adjustments even when the resin skeleton is left in the substrate.

Specifically, in a positive electrode substrate having a resin skeleton, a nickel coating layer coating a resin serving as the skeleton may undesirably be delaminated by repeated charging and discharging since the physical properties (such as elongation percentage and strength) of the resin greatly differ from those of the nickel coating layer coating the resin. By contrast, in the positive electrode for an alkaline storage battery according to the present invention, the average thickness of the nickel coating layer is adjusted to be not more than 5 μm. As a result of an examination made by the present inventors, it has been proved that, by adjusting the average thickness of the nickel coating layer to a value of not more than 5 μm, the adhesion between the resin and the nickel coating layer is improved and the delamination of the nickel coating layer can be suppressed over a long period of time. By thus adjusting the average thickness of the nickel coating layer to a value of not more than 5 μm, the positive electrode substrate is allowed to retain an excellent current collectivity over a long period of time.

In a conventional positive electrode using a foamed nickel substrate, the average thickness of the nickel skeleton has been adjusted to be larger than 5 μm such that the substrate has a sufficient strength to be used as a current collecting substrate. By contrast, in the positive electrode for an alkaline storage battery according to the present invention, the average thickness of the nickel coating layer of the positive electrode substrate can be adjusted to be not more than 5 μm. This allows a reduction in the amount of nickel compared with that in the positive electrode using the foamed nickel substrate and thereby allows a reduction in cost.

Accordingly, by adjusting the average thickness of the nickel coating layer to a value of not less than 0.5 μm and not more than 5 μm, the cycle lifetime characteristic of the battery can be improved.

In the case where the resin skeleton is left in the positive electrode substrate and the average thickness of the nickel coating layer of the positive electrode substrate is reduced to 5 μm or less as in the positive electrode for an alkaline storage battery according to the present invention, the electric resistance of the positive electrode substrate tends to be higher than that of the conventional foamed nickel substrate. As a result, there is the possibility that the high-rate discharge characteristic of the battery particularly lowers compared with the case where the conventional foamed nickel substrate is used.

By contrast, in the positive electrode for an alkaline storage battery according to the present invention, metal cobalt is contained in addition to the positive electrode active material. Since metal cobalt is high in conductivity, a network with an excellent conductivity can be formed and the high-rate discharge characteristic can be improved by causing metal cobalt to be contained.

In the case where the resin skeleton is left in the positive electrode substrate as in the positive electrode for an alkaline storage battery according to the present invention, it becomes difficult to anneal the resin substrate plated with nickel in the process of manufacturing the positive electrode substrate. As a result, a crystal of nickel cannot be grown sufficiently so that the crystal size of nickel is small. When the crystal size of nickel is small, the corrosion (passivation by oxidation) of nickel tends to readily proceed under the influence of oxygen generated as a secondary reaction during the final period of charging. Accordingly, when charging and discharging is repeated, the corrosion of nickel may proceed to cause problems such as the lowering of the current collectivity of the positive electrode substrate and the reduction or dearth of the electrolyte, so that the cycle lifetime characteristic significantly lowers.

By contrast, in the positive electrode for an alkaline storage battery according to the present invention, cobalt oxyhydroxide having a β-type crystal structure is also contained in addition to metal cobalt. As a result of an examination made by the present inventors, it has been proved that the oxygen overvoltage during charging can be increased by causing metal cobalt and cobalt oxyhydroxide having a β-type crystal structure to be contained. The arrangement can suppress the oxygen-generating reaction during charging and suppress the corrosion (passivation by oxidation) of nickel. Accordingly, by using the positive electrode for an alkaline storage battery according to the present invention, it becomes possible to improve the cycle lifetime characteristic of the battery.

Thus, in the positive electrode for an alkaline storage battery according to the present invention, each of the high-rate discharge characteristic and cycle lifetime characteristic of the battery can be improved by causing metal cobalt and cobalt oxyhydroxide having a β-type crystal structure to be contained.

As a result of an examination made by the present inventors, it has been proved that, when either of metal cobalt and cobalt oxyhydroxide having a β-type crystal structure is contained alone, the oxygen overvoltage during charging cannot be increased.

(19) Furthermore, in the aforementioned positive electrode for an alkaline storage battery, preferably, a proportion of the nickel coating layer to the positive electrode substrate is not less than 30 wt % and not more than 80 wt %.

Even when the average thickness of the nickel coating layer is adjusted to be not less than 0.5 μm and not more than 5 μm as described above, the intrinsic electric resistance of the positive electrode substrate increases undesirably when the proportion of the resin skeleton to the positive electrode substrate is excessively increased. As a result, the current collectivity of the positive electrode substrate suffers a significant reduction and consequently the charge/discharge efficiency of the battery may undesirably lower. To prevent this, in the positive electrode for an alkaline storage battery according to the present invention, the proportion of the nickel coating layer to the positive electrode substrate is adjusted to be not less than 30 wt % and not more than 80 wt % (or, in other words, the proportion of the resin skeleton is adjusted to be not less than 20 wt % and not more than 70 wt %). By adjusting the proportion of the nickel coating layer to the positive electrode substrate to a value of not less than 30 wt %, the electric resistance of the positive electrode substrate can be reduced and the current collectivity thereof can be improved.

The proportion of the nickel coating layer to the positive electrode substrate is preferably maximized because the electric resistance can be lowered as the proportion of the nickel coating layer to the positive electrode substrate is higher. However, an increase in the proportion of nickel is synonymous to a reduction in the proportion of the resin skeleton (the thinning of the resin skeleton). Accordingly, when the proportion of the nickel coating layer to the positive electrode substrate is excessively increased (specifically, over 80 wt %), the intrinsic strength of the positive electrode substrate greatly lowers. As a result, a problem such as a crack formed in the nickel coating layer occurs and the current collectivity may be reduced significantly thereby. To prevent this, in the positive electrode for an alkaline storage battery according to the present invention, the proportion of the nickel coating layer to the positive electrode substrate is limited to 80 wt % or less. As a result, the current collectivity can be improved without the possibility of causing a problem such as a crack formed in the nickel coating layer.

(20) Furthermore, in any one of the aforementioned positive electrodes for an alkaline storage battery, preferably, the resin skeleton is any of a foamed resin, a non-woven fabric, and a woven fabric.

Each of the foamed resin, the non-woven fabric, and the woven fabric has a three-dimensional network structure and has a void portion in which a plurality of pores are coupled in three dimensions. In addition, the size (pore diameter) of the void portion can be adjusted to a specified size relatively easily. Accordingly, by using any of the foamed resin, the non-woven fabric, and the woven fabric as the resin skeleton, it becomes possible to properly fill the specified amount of the positive electrode material. Among them, the non-woven fabric and the woven fabric are particularly preferred since the size (pore diameter) of the void portion can be freely adjusted by adjusting the thicknesses and number of fibers thereof and therefore the size (pore diameter) of the void portion can be adjusted easily.

(21) In the aforementioned positive electrode for an alkaline storage battery, preferably, the resin skeleton is a non-woven fabric.

A non-woven fabric is preferred since the size (pore diameters) of the void portion can be freely adjusted by adjusting the thicknesses and number of the fibers thereof so that the size (pore diameters) of the void portions is adjusted particularly easily. A non-woven fabric is also preferred in that the strength of adhesion between the fibers can be easily adjusted by adjusting the proportion of adhesive fibers (fibers at a low softening temperature). By combining thick fibers with fine fibers, a positive electrode for an alkaline storage battery suited for various applications can be obtained. Specifically, by increasing the proportion of the thick fibers, the strength of the resin skeleton can be enhanced. Conversely, by increasing the proportion of the fine fibers, the retention of electrode materials such as an active material can be improved (the omission thereof can be prevented) and the adhesion between the resin skeleton and the electrode materials in the electrode can further be enhanced. Accordingly, by adjusting the proportion between the thick fibers and the fine fibers, it becomes possible to obtain a desired electrode suited for applications.

(22) In any one of the aforementioned positive electrodes for an alkaline storage battery, preferably, the resin skeleton is made of at least one resin selected from the group consisting of polypropylene, polyethylene, polyvinyl alcohol, polyester, nylon, polymethyl pentene, polystyrene, and polytetrafluoroethylene.

As stated previously, in the positive electrode for an alkaline storage battery according to the present invention, the resin skeleton is coated with the nickel coating layer so that the possibility of the exposure of the resin skeleton is low. However, in the case where a plurality of positive electrode substrates are manufactured by cutting a large substrate, there is the possibility that the resin skeleton is exposed from a cut surface. In the case where the positive electrode (positive electrode substrate) with the exposed resin skeleton is used in an alkaline storage battery, the electrolyte comes in contact with the resin skeleton so that alkali resistance is required of the resin skeleton.

By contrast, in the positive electrode for an alkaline storage battery according to the present invention, the resin skeleton of the positive electrode substrate is formed from at least one resin selected from polypropylene, polyethylene, polyvinyl alcohol, polyester, nylon, polymethyl pentene, polystyrene, and polytetrafluoroethylene. Since these resins are excellent in alkali resistance, even when the resin skeleton is exposed, it is free from the influence of the alkaline electrolyte. Consequently, the positive electrode for an alkaline storage battery according to the present invention has no possibility of suffering a problem such as the lowering of the strength under the influence of the alkaline electrolyte.

The resin skeleton may be formed from only one of the resins listed above or formed by mixing two or more resins (e.g., by producing a non-woven fabric from two or more different fibers).

(23) In any one of the aforementioned positive electrodes for an alkaline storage battery, preferably, the metal cobalt is contained at a ratio of 2 to 10 parts by weight to 100 parts by weight of the positive electrode active material.

In the positive electrode for an alkaline storage battery according to the present invention, metal cobalt is contained at a ratio of 2 parts by weight or more to 100 parts by weight of the positive electrode active material so that an excellent current collectivity is obtainable. Accordingly, by using the positive electrode for an alkaline storage battery according to the present invention, it becomes possible to obtain an alkaline storage battery excellent in high-rate discharge characteristic. By limiting the amount of metal cobalt to 10 parts by weight or less relative to 100 parts by weight of the positive electrode active material, it becomes possible to suppress the lowering of the filling amount of the positive electrode active material (nickel hydroxide) and suppress the lowering of the energy density of the positive electrode.

(24) In any one of the aforementioned positive electrodes for an alkaline storage battery, preferably, the cobalt oxyhydroxide having a β-type crystal structure is contained at a ratio of 2 to 10 parts by weight to 100 parts by weight of the positive electrode active material.

In the positive electrode for an alkaline storage battery according to the present invention, cobalt oxyhydroxide having a β-type crystal structure is contained at a ratio of 2 parts by weight or more to 100 parts by weight of the positive electrode active material so that it becomes possible to greatly increase the oxygen overvoltage during charging. Accordingly, by using the positive electrode for an alkaline storage battery according to the present invention, it becomes possible to obtain an alkaline storage battery excellent in cycle lifetime characteristic. By limiting the amount of cobalt oxyhydroxide having a β-type crystal structure to 10 parts by weight or less relative to 100 parts by weight of the positive electrode active material, it becomes possible to suppress the lowering of the filling amount of the positive electrode active material (nickel hydroxide) and suppress the lowering of the energy density of the positive electrode.

(25) In any one of the aforementioned positive electrodes for an alkaline storage battery, preferably, a surface of the positive electrode active material is coated with the cobalt oxyhydroxide having a β-type crystal structure.

In the positive electrode for an alkaline storage battery according to the present invention, the surface of the positive electrode active material is coated with cobalt oxyhydroxide having a β-type crystal structure. This allows cobalt oxyhydroxide having a β-type crystal structure to be uniformly distributed within the positive electrode. As a result, the oxygen overvoltage during charging is further increased and the corrosion of nickel can be more effectively suppressed. Accordingly, it becomes possible to further improve the cycle lifetime characteristic of the battery.

(26) In any one of the aforementioned positive electrodes for an alkaline storage battery, preferably, an average valence of cobalt contained in the cobalt oxyhydroxide having a β-type crystal structure is not less than 2.6 and not more than 3.0.

By adjusting the average valence of cobalt contained in cobalt oxyhydroxide having a β-type crystal structure to a value of not less than 2.6, the oxygen overvoltage during charging can further be increased. This makes it possible to suppress the corrosion of nickel and further improve the cycle lifetime characteristic of the battery.

When the average valence of cobalt is larger than 3.0, the balance of charges in a cobalt oxyhydroxide crystal is disturbed so that a transition from a β-type crystal structure to a γ-type crystal structure is more likely to occur. Since cobalt oxyhydroxide having a γ-type crystal structure has high oxidizing power (is readily reducible), it undesirably oxidizes metal cobalt contained in the positive electrode. This may prevent the formation of a conductive network inside the positive electrode and significantly lower the active-material utilization ratio. By contrast, in the positive electrode for an alkaline storage battery according to the present invention, the average valence of cobalt is adjusted to a value of not more than 3.0. As a result, it is possible to retain the β-type crystal structure of cobalt oxyhydroxide and there is no probability of the occurrence of a problem as mentioned above.

(27) In any one of the aforementioned positive electrodes for an alkaline storage battery, preferably, the positive electrode active material contains at least either of zinc and magnesium in a solid solution state in each of the nickel hydroxide particles.

In the positive electrode for an alkaline storage battery according to the present invention, the positive electrode substrate has a resin skeleton. In such a positive electrode substrate, the physical properties (such as elongation percentage and strength) of a resin forming the skeleton greatly differ from those of the nickel coating layer coating the resin. Accordingly, there is the possibility that the expansion/contraction of the positive electrode substrate may cause a crack in the nickel coating layer or the delamination of the nickel coating layer. To circumvent such problems, therefore, the expansion/contraction of the positive electrode substrate is preferably suppressed maximally.

It is to be noted that a crystal of nickel hydroxide tends to suffer a change in the crystal structure thereof through charging and discharging and greatly expand. When nickel hydroxide particles contained in the positive electrode active material filled in the void portion of the positive electrode substrate greatly expand through charging and discharging, the positive electrode substrate is enlarged forcibly thereby to greatly expand. As a result, there are cases where a crack is formed in the nickel coating layer of the positive electrode substrate and where the nickel coating layer delaminates as described above.

By contrast, in the positive electrode for an alkaline storage battery according to the present invention, the positive electrode active material contains at least either of zinc and magnesium in a solid solution state in each of the nickel hydroxide particles. By causing zinc and magnesium to be contained in a solid solution state in the nickel hydroxide crystal, a change in the crystal structure resulting from charging and discharging can be suppressed and the expansion of the crystal resulting from charging and discharging can also be suppressed. This can suppress the expansion of the positive electrode substrate resulting from charging and discharging and reduce the possibility of the occurrence of a crack or delamination in the nickel coating layer.

(28) Further, in any one of the aforementioned positive electrodes for an alkaline storage battery, preferably, in addition to the positive electrode active material, at least either of yttrium oxide and zinc oxide is contained in the void portion of the positive electrode substrate.

In the positive electrode for an alkaline storage battery, an oxygen-generating reaction proceeds as a secondary reaction during the final period of charging. It is known that, since the oxygen-generating reaction proceeds particularly readily in a high-temperature state, the reaction of nickel hydroxide as a primary reaction is inhibited thereby and the resulting lowering of the active-material utilization ratio causes a reduction in charge efficiency. As a result of an examination made by the present inventors, it has been proved that, in the case where the positive electrode substrate having the resin skeleton is used, the charge efficiency of the battery in a high-temperature state slightly lowers compared with the case where the foamed nickel substrate is used.

To prevent this, in the positive electrode for an alkaline storage battery according to the present invention, at least either of yttrium oxide and zinc oxide is contained in addition to the positive electrode active material. As a result, an oxygen overvoltage can be increased so that it becomes possible to suppress the oxygen-generating reaction during the final period of charging and improve the charge efficiency even in a high-temperature state.

Preferably, both of yttrium oxide and zinc oxide are contained since the arrangement can further increase the oxygen overvoltage and provide an excellent charge efficiency.

(29) Further, in any one of the aforementioned positive electrodes for an alkaline storage battery, preferably, the nickel coating layer is formed on a surface of the resin skeleton by any of an electroplating method, an electroless plating method, and a vapor deposition method.

In the positive electrode for an alkaline storage battery according to the present invention, the nickel coating layer is formed on the surface of the resin skeleton by any of an electroplating method, an electroless plating method, and a vapor deposition method. The nickel coating layer formed by any of the methods listed above can uniformly coat the surface of the resin skeleton. This allows an improvement in current collectivity and also allows an improvement in the charge/discharge efficiency (active-material utilization ratio) of the battery.

(30) Another solving means is an alkaline storage battery having any of the positive electrodes for an alkaline storage battery described above.

The alkaline storage battery according to the present invention has any of the positive electrodes described above. That is, since the alkaline storage battery according to the present invention uses the positive electrode substrate having the resin skeleton, the positive electrode substrate and also the positive electrode are solidified. As a result, the durability of the positive electrode (positive electrode substrate) is improved and hence the lifetime of the alkaline storage battery can be improved. Since the labor of burning off the resin skeleton can be omitted, the cost is reduced.

In addition, in the positive electrode substrate, the average thickness of the nickel coating layer is adjusted to be not less than 0.5 μm and not more than 5 μm. The arrangement allows the delamination of the nickel coating layer to be suppressed over a long period of time and thereby allows proper charging and discharging to be performed. In other words, the arrangement allows an improvement in the cycle lifetime characteristic of the battery. Moreover, metal cobalt and cobalt oxyhydroxide having a β-type crystal structure are contained in the positive electrode in addition to the positive electrode active material. By using the positive electrode containing these, it becomes possible to improve each of the high-rate discharge characteristic and the cycle lifetime characteristic.

### BRIEF DESCRIPTION OF DRAWINGS

FIG. 1 is a characteristic view showing the relationship between the average thickness (μm) of the nickel coating layer of a positive electrode substrate and an active-material utilization ratio (%);

FIG. 2 is a characteristic view showing the relationship between the proportion (wt %) of the nickel coating layer to the positive electrode substrate and the active-material utilization ratio (%);

FIG. 3 is a characteristic view showing the relationship between the filling amount of a positive electrode active material (the scaling ratio to the weight of the positive electrode substrate) and the active-material utilization ratio (%);

FIG. 4 is a characteristic view showing the relationship between the average thickness (μm) of the nickel coating layer of the positive electrode substrate and the active-material utilization ratio (%);

FIG. 5 is a characteristic view showing the relationship between the content (part or parts by weight) of metal cobalt relative to a positive electrode and an active-material utilization ratio B (%);

FIG. 6 is a characteristic view showing the relationship between the average thickness (μm) of the nickel coating layer of the positive electrode substrate and an active-material utilization ratio A (%);

FIG. 7 is a characteristic view showing the relationship between the average thickness (μm) of the nickel coating layer of the positive electrode substrate and an active-material utilization ratio D (%);

FIG. 8 is a characteristic view showing the relationship between the content (part or parts by weight) of metal cobalt relative to the positive electrode and the ratio (B/A) between utilization ratios×100(%); and

FIG. 9 is a characteristic view showing the relationship between the content (part or parts by weight) of β-CoOOH relative to the positive electrode and the ratio (D/A) between utilization ratios×100(%).

### BEST MODE FOR CARRYING OUT THE INVENTION

A description will be given next to the embodiments of the present invention.

### Example 1

### Step 1: Production of Nickel-Coated Resin Substrate

First, foamed propylene having a void portion in which pores with an average pore diameter of 350 μm are coupled in three dimensions and having an intrinsic thickness of 1.4 mm was prepared. Then, an aqueous solution containing tin chloride and an aqueous solution containing palladium chloride were circulated in the foamed propylene so that the foamed polypropylene was catalyzed. Then, the catalyzed foamed polypropylene was immersed in a nickel plating solution containing nickel sulfate, sodium citrate, hydrated hydradine as a reductant, and ammonia as a pH adjustor and, in this state, the nickel plating solution was heated to 80° C. and circulated. In this manner, nickel electroless plating was performed with respect to the foamed polypropylene. The respective composition concentrations of the nickel plating solution and the immersion time were adjusted such that the proportion of the weight of the nickel plate to that of the substrate after plating was 63 wt %.

Subsequently, after the plating solution became substantially transparent, the substrate with a nickel coating layer was washed with water and then dried. Thus, a nickel-coated resin substrate comprising: a resin skeleton made of the foamed polypropylene; and the nickel coating layer coating the resin skeleton and also having the void portion in which the plurality of pores are coupled in three dimensions could be obtained. At this time, the proportion of the nickel coating layer to the entire nickel-coated resin substrate, which was calculated from a change in the weight of the actually obtained nickel-coated resin substrate, was 60 wt %. As a result of examining the thickness of the nickel coating layer by observing an enlarged image of the rupture cross section of the nickel-coated resin substrate by using a SEM (scanning electron microscope), the average thickness thereof was 1.5 μm.

### Step 2: Production of Positive Electrode Active Material

Next, a positive electrode active material was produced. Specifically, a solution mixture containing nickel sulfate and magnesium sulfate, an aqueous sodium hydroxide solution, and an aqueous ammonia solution were prepared first and each of the solutions was supplied continuously at a constant flow rate into a reactor held at 50° C. The mixture ratio between nickel sulfate and magnesium sulfate in the solution mixture containing nickel sulfate and magnesium sulfate was adjusted such that the ratio of the number of moles of magnesium to the total number of moles of nickel and magnesium was 5 mol %.

Then, after the pH in a reaction vessel became constant at 12.5 and the balance between the respective concentrations of a metal salt and metal hydroxide particles became constant so that a steady state was reached, a suspension that has overflown from the reaction vessel was collected and a precipitate was separated by decantation. Thereafter, the precipitate was washed with water and dried so that nickel hydroxide powder having an average particle diameter of 10 μm was obtainable.

As a result of performing composition analysis with respect to the obtained nickel hydroxide powder, the proportion of magnesium to all the metal elements (nickel and magnesium) contained in the nickel hydroxide particles was 5 mol % in the same manner as in the solution mixture used for synthesis. As a result of recording an X-ray diffraction pattern using a CuKα beam, it was recognized that each of the particles was composed of a β-Ni(OH)₂-type single-phase crystal. In other words, it was recognized that magnesium was solid-solved in the nickel hydroxide crystal.

### Step 3: Production of Nickel Positive Electrode

Next, a nickel positive electrode was produced. Specifically, the positive electrode active material powder obtained in Step 2 was mixed with cobalt hydroxide particles and water was added thereto. The resulting mixture was kneaded into a paste. The paste was filled in the nickel-coated resin substrate obtained in Step 1, dried, and pressure-molded, whereby a nickel positive electrode board was produced. It is to be noted that a lead welding portion with no void portion was formed by rolling the portion of the nickel-coated resin substrate to which an electrode lead was to be welded later. Since the void portion does not exist in the lead welding portion, the paste is prevented from being filled therein.

Then, the nickel positive electrode board was cut into a specified size and the electrode lead was bonded to the lead welding portion by ultrasonic welding so that the nickel positive electrode with a theoretical capacity of 1300 mAh was obtainable. The theoretical capacity of the nickel positive electrode was calculated by assuming that nickel in the active material underwent a single-electron reaction. It is also assumed that, in Example 1, the lead welding portion (the portion in which the positive electrode active material was not filled) is excluded from the nickel positive electrode and that the nickel-coated resin substrate included in the nickel positive electrode is the positive electrode substrate.

Thereafter, the weight of the positive electrode active material contained in the nickel positive electrode according to Example 1 was measured to be 4.65 g. On the other hand, the weight of the positive electrode substrate was 0.63 g. Accordingly, in Example 1, the filling amount of the positive electrode active material was 7.38 times the weight of the positive electrode substrate. From the nickel positive electrode, the positive electrode active material powder and cobalt hydroxide powder were removed and the pore diameter distribution in the positive electrode substrate was measured by using a mercury porosimeter (Auto Pore III 9410 commercially available from Shimadzu Corporation). Based on the pore diameter distribution, the average pore diameter of the positive electrode substrate according to Example 1 was calculated to be 160 μm.

### Step 4: Production of Alkali Storage Battery

Next, a negative electrode containing a hydrogen absorbing alloy was produced by a known method. Specifically, hydrogen absorbing alloy MmNi_{3.55}CO_{0.75}Mn_{0.4}Al_{0.3} powder with a particle diameter of about 30 μm was prepared and water and carboxymethyl cellulose as a binder were added thereto. The resulting mixture was kneaded into a paste. The paste was pressure-filled in an electrode support so that a hydrogen-absorbing-alloy negative electrode board was produced. The hydrogen-absorbing-alloy negative electrode board was cut into a specified size to obtain a negative electrode with a capacity of 2000 mAh.

Then, the negative electrode and the nickel positive electrode described above were rolled up with a separator composed of a sulfonated polypropylene non-woven fabric having a thickness of 0.15 mm interposed therebetween, thereby forming spiral electrodes. Subsequently, the electrodes were inserted into a bottomed cylindrical battery container made of a metal, which had been prepared separately, and 2.2 ml of a 7 mol/l aqueous potassium hydroxide solution was injected therein. Thereafter, the opening of the battery container was tightly closed with a sealing plate having a safety valve with a working pressure of 2.0 MPa, whereby a cylindrical closed nickel-metal hydride storage battery of the AA size was produced.

### Comparative Example 1

Next, for comparison with Example 1 described above, an alkaline storage battery having a positive electrode substrate different from that used in Example 1 was produced. Specifically, in Step 1, a resin skeleton of a foamed polyurethane sheet was plated with nickel and then the resin skeleton was burned off, whereby a foamed nickel substrate was produced. The average thickness of the nickel skeleton of the foamed nickel substrate was 5.5 μm. Thereafter, a cylindrical closed nickel-metal hydride storage battery of the AA size was produced in the same manner as in Steps 2 to 4 of Example 1. In Comparative Example 1 also, the theoretical capacity of the positive electrode was assumed to be 1300 mA in the same manner as in Example 1. The weight of the positive electrode active material contained in the positive electrode according to Comparative Example 1 was measured to be 4.65 g, which is the same as in Example 1. The weight of the positive electrode substrate was 1.9 g, which is about 3 times the weight (0.63 g) thereof in Example 1. Thus, in Comparative Example 1, the filling amount of the positive electrode active material was 2.45 times the weight of the positive electrode substrate.

(Evaluation of Battery Characteristics)

Next, characteristic evaluation was performed with respect to the respective alkaline storage batteries according to Example 1 and Comparative Example 1.

First, the charge/discharge efficiencies after an initial charge/discharge cycle were evaluated. Specifically, a charge/discharge cycle in which each of the batteries was charged with a current of 0.1 C at 20° C. for 15 hours and then discharged to release a current of 0.2 C till the battery voltage became 1.0 V was repeatedly performed till the discharge capacity was stabilized. Then, after the discharge capacity was stabilized, each of the batteries was charged with a current of 1 C at 20° C. for 1.2 hours and then discharged to release a current of 1 C till the battery voltage became 0.8 V. Since the theoretical capacity of each of the alkaline storage batteries according to Example 1 and Comparative Example 1 was 1300 mAh, 1 C=1.3 A was satisfied.

Based on the discharge capacity obtained at that time, the active-material utilization ratio (active-material utilization ratio after the initial charging and discharging) was calculated for each of the batteries. It is to be noted that the active-material utilization ratio was calculated relative to a theoretical amount of electricity when nickel in the active material underwent a single-electron reaction. Specifically, the ratio of the discharge capacity to 1300 mA as the theoretical capacity of the positive electrode is shown.

Each of the calculated active-material utilization ratios of Example 1 and Comparative Example 1 showed a high value of 97%. From the result, it was found that an excellent charge/discharge efficiency was obtainable from each of the alkaline storage batteries according to Example 1 and Comparative Example 1.

Then, the charge/discharge efficiencies after a long-term charge/discharge cycle were evaluated. Specifically, a charge/discharge cycle in which each of the batteries was charged with a current of 0.1 C at 20° C. for 15 hours and then discharged to release a current of 0.2 C till the battery voltage became 1.0 V was repeatedly performed till the discharge capacity was stabilized. After the discharge capacity was stabilized, a charge/discharge cycle in which each of the batteries was charged with a current of 1 C at 20° C. for 1.2 hours and then discharged to release a current of 1 C till the battery voltage became 0.8 V was performed 500 times. Thereafter, based on the discharge capacity in the 500-th cycle, the active-material utilization ratio (active-material utilization ratio after 500 cycles) was calculated for each of the batteries.

According to the result of the calculation, the active-material utilization ratio of the alkaline storage battery according to Example 1 showed a high value of 90%, while the active-material utilization ratio of the alkaline storage battery according to Comparative Example 1 lowered to 80%. From the result, it can be said that the alkaline storage battery according to Example 1 retains an excellent charge/discharge efficiency over a long period of time. It can also be said that the positive electrode substrate (positive electrode) used in the alkaline storage battery according to Example 1 also retains an excellent current collectivity over a long period of time.

After the long-term charge/discharge cycle test, each of the batteries was disassembled and examined with the result that the positive electrode of the alkaline storage battery according to Comparative Example 1 had expanded to have a thickness about 10% larger than that prior to the charge/discharge cycle test. As a result, the separator was compressed so that the electrolyte in the separator was significantly reduced and the internal resistance was significantly increased. This may be a conceivable cause of the lowered active-material utilization ratio.

By contrast, in the alkaline storage battery according to Example 1, the expansion of the positive electrode was suppressed so that the electrolyte in the separator was hardly reduced and the internal resistance was also hardly increased. A conceivable reason for this is that, since the positive electrode substrate had the resin skeleton in Example 1, unlike in Comparative Example 1, the positive electrode substrate was solidified and the deformation caused by the expansion of the positive electrode active material (nickel hydroxide) resulting from charging and discharging could be suppressed.

Since the physical properties (such as elongation percentage and strength) of the resin forming the skeleton greatly differ from those of the nickel coating layer coating the resin in the positive electrode substrate according to Example 1, when the expansion/contraction of the positive electrode substrate is significant, a crack may be formed in the nickel coating layer or the nickel coating layer may be delaminated. To circumvent such problems, the expansion/contraction of the positive electrode substrate is preferably suppressed maximally. However, a crystal of nickel hydroxide composing the positive electrode active material tends to suffer a change in the crystal structure thereof through charging and discharging and greatly expand.

However, in the positive electrode according to Example 1, a crack or delamination was not observed in the nickel coating layer. A conceivable reason for this is that magnesium was contained in a solid solution state in the crystal of nickel hydroxide composing the positive electrode active material. It is considered that, as a result, a change in the crystal structure resulting from charging and discharging could be suppressed and the expansion of the crystal resulting from charging and discharging could be suppressed. Therefore, it is considered that the expansion of the positive electrode substrate resulting from charging and discharging could be suppressed and the nickel coating layer did not suffer a crack or delamination.

### Example 2

In Example 2, five types of nickel-coated resin substrates in which the average thicknesses of the nickel coating layers were different were produced in Step 1 by varying the composition concentrations of the nickel plating solutions and the immersion times for foamed polypropylene. For the five types of nickel-coated resin substrates, the average thicknesses of the nickel coating layers were examined to be 0.35 μm, 0.5 μm, 2 μm, 5 μm, and 7 μm. In Example 2, the proportion of the nickel coating layer to the entire substrate was adjusted for each of the nickel-coated resin substrates to a range of not less than 30 wt % and not more than 80 wt % by adjusting the thicknesses (numbers) of the skeletons of foamed polypropylene.

Then, five types of nickel positive electrodes were produced in the same manner as in Steps 2 and 3 of Example 1. In Example 2 also, the theoretical capacity of each of the positive electrodes was assumed to be 1300 mAh in the same manner as in Example 1. In each of the five types of nickel positive electrodes according to Example 2, the filling amount of the positive electrode active material was adjusted to a range of not less than 3 times and not more than 10 times the weight of the positive electrode substrate. Thereafter, five types of cylindrical closed nickel-metal hydride storage batteries each of the AA size were produced in the same manner as in Step 4 of Example 1.

(Evaluation of Battery Characteristics)

Next, characteristic evaluation was performed with respect to each of the five types of alkaline storage batteries according to Example 2.

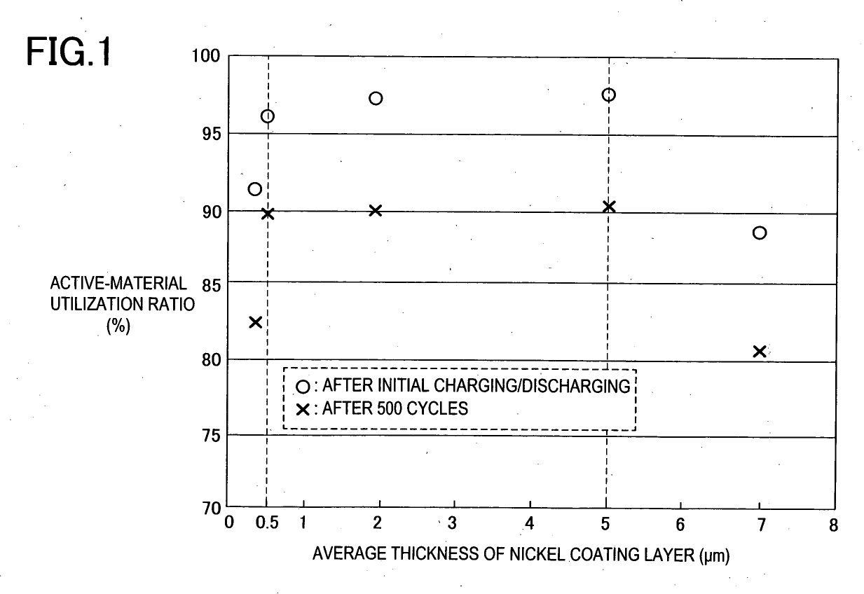

First, an initial charge/discharge cycle test was performed with respect to each of the five types of alkaline storage batteries in the same manner as in Example 1. Then, the active-material utilization ratio (active-material utilization ratio after initial charging and discharging) was calculated for each of the five types of alkaline storage batteries. The results are shown by the marks ∘ in FIG. 1. As shown in FIG. 1, in the batteries in which the average thicknesses of the nickel coating layers were adjusted to 0.5 μm, 2 μm, and 5 μm, the active-material utilization ratios became 95% or more (specifically, 96.1%, 97.3%, and 97.5% in this order) so that the excellent charge/discharge efficiencies were obtainable. By contrast, in the battery in which the average thickness of the nickel coating layer was adjusted to 0.35 μm, the active-material utilization ratio became 91.2% so that the charge/discharge efficiency was slightly inferior. In the battery in which the average thickness of the nickel coating layer was adjusted to 7 μm, the active-material utilization ratio was 88.8%, which was the lowest.

After the initial charge/discharge cycle test, each of the batteries was disassembled and the SEM image of the cross section of each of the positive electrodes was observed with the result that, in the battery in which the average thickness of the nickel coating layer was adjusted to 7 μm, a part of the nickel coating layer was delaminated from the positive electrode substrate. This may be a conceivable cause of the lowered active-material utilization ratio. In the battery in which the average thickness of the nickel coating layer was adjusted to 0.35 μm, on the other hand, a sufficient current collectivity could not be obtained conceivably because the nickel coating layer was extremely thinned so that the charge/discharge efficiency was slightly inferior.

Next, the long-term charge/discharge cycle test (500 cycles) was performed with respect to each of the five types of alkaline storage batteries in the same manner as in Example 1. Then, the active-material utilization ratio (active-material utilization ratio after 500 cycles) was calculated for each of the five types of alkaline storage batteries. The results are shown by the marks x in FIG. 1. As shown in FIG. 1, in the battery in which the average thickness of the nickel coating layer was adjusted to 0.35 μm, the active-material utilization ratio after 500 cycles lowered to 82.4%. In the battery in which the average thickness of the nickel coating layer was adjusted to 7 μm, the active-material utilization ratio after 500 cycles further lowered to 81.1%.

By contrast, in the batteries in which the average thicknesses of the nickel coating layers were adjusted to 0.5 μm, 2 μm, and 5 μm, the active-material utilization ratios after 500 cycles lowered from the active-material utilization ratios after initial charging and discharging but still showed high values of about 90% (specifically, 89.2%, 89.8%, and 90.3% in this order). From the result, it can be said that, to retain an excellent charge/discharge efficiency over a long period of time, the average thickness of the nickel coating layer of the positive electrode substrate should be adjusted to be not less than 0.5 μm and not more than 5 μm. It can also be said that the active-material utilization ratio (charge/discharge efficiency) which had been held excellent over a long period of time indicates that the current collectivity of the positive electrode (positive electrode substrate) of the battery had also been held excellent over a long period of time. Hence, it can be said that, to retain the excellent current collectivity of the positive electrode substrate excellent over a long period of time, the average thickness of the nickel coating layer of the positive electrode substrate should be adjusted to be not less than 0.5 μm and not more than 5 μm.

### Example 3

In Example 2, in the production of the nickel-coated resin substrates (positive electrode substrates), the average thicknesses of the nickel coating layers were adjusted to the range of 0.35 μm to 7 μm by adjusting the thicknesses (numbers) of the resin skeletons (foamed polypropylene), while the proportions of the nickel coating layers to the entire substrates were held in a range of not less than 30 wt % and not more than 80 wt %. By contrast, in Example 3, equal resin skeletons (foamed polypropylene) were used and the proportions of the nickel coating layers to the entire substrates were varied in a range of not less than 27 wt % and not more than 84 wt % by adjusting only the respective composition concentrations of the nickel plating solutions and the immersion times, while the average thicknesses of the nickel coating layers were held in the range of 0.5 μm to 5 μm.

Specifically, in Step 1, five types of nickel-coated resin substrates in which the proportions of the nickel coating layers to the entire substrates were different were produced by varying the respective composition concentrations of the nickel plating solutions and the immersion times for foamed polypropylene which is equal to that used in Example 1. The proportions of the nickel coating layers to the entire substrates in the five types of nickel-coated resin substrates were examined to be 27 wt %, 30 wt %, 60 wt %, 80 wt %, and 84 wt %. Subsequently, five types of nickel positive electrodes were produced in the same manner as in Steps 2 and 3 of Example 1. In Example 3 also, the theoretical capacity of each of the positive electrodes was assumed to be 1300 mAh in the same manner as in Example 1. In each of the five types of nickel positive electrodes according to Example 3, the filling amount of the positive electrode active material was adjusted to a range of not less than 3 times and not more than 10 times the weight of the positive electrode substrate. Thereafter, five types of cylindrical closed nickel-metal hydride storage batteries each of the AA size were produced in the same manner as in Step 4 of Example 1.

(Evaluation of Battery Characteristics)

Next, characteristic evaluation was performed with respect to each of the five types of alkaline storage batteries according to Example 3.

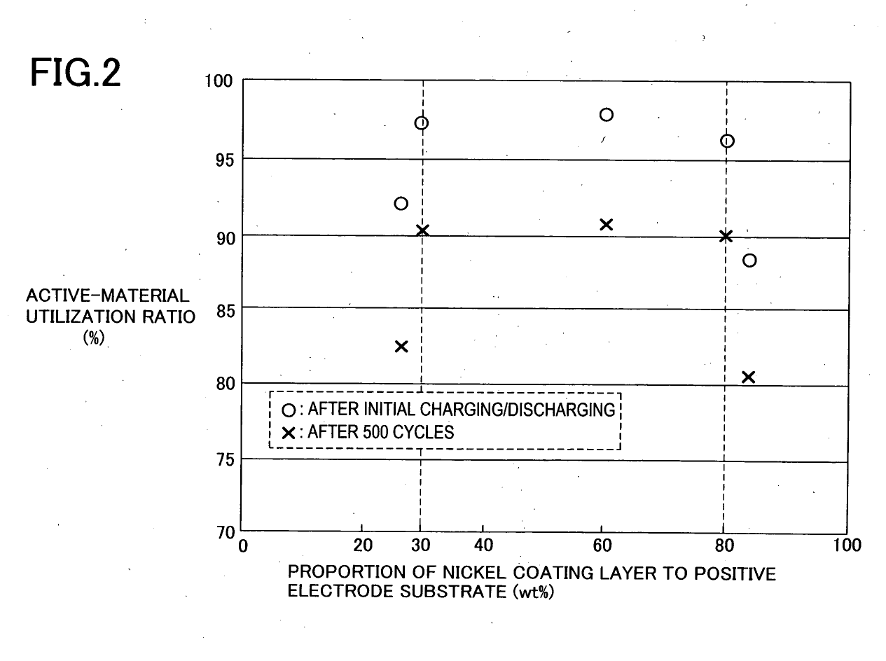

First, the initial charge/discharge cycle test was performed with respect to each of the five types of alkaline storage batteries in the same manner as in Example 1. Then, the active-material utilization ratio (active-material utilization ratio after initial charging and discharging) was calculated for each of the five types of alkaline storage batteries. The results are shown by the marks ∘ in FIG. 2. As shown in FIG. 2, in the batteries in which the respective proportions of the nickel coating layers to the positive electrode substrates were adjusted to 30 wt %, 60 wt %, and 80 wt %, the active-material utilization ratios became 95% or more (specifically, 97.3%, 97.8%, and 96.1% in this order) so that the excellent charge/discharge efficiencies were obtainable. By contrast, in the battery in which the proportion of the nickel coating layer to the positive electrode substrate was adjusted to 27 wt %, the active-material utilization ratio became 92.3% so that the charge/discharge efficiency was slightly inferior. In the battery in which the proportion of the nickel coating layer to the positive electrode substrate was adjusted to 84 wt %, the active-material utilization ratio was 88.2%, which was the lowest.

After the initial charge/discharge cycle test, each of the batteries was disassembled and the SEM image of the cross section of each of the positive electrodes was observed with the result that, in the battery in which the proportion of the nickel coating layer to the positive electrode substrate was adjusted to 84 wt %, a crack was observed in the nickel coating layer of the positive electrode substrate. This is conceivably because the excessively increased proportion of the nickel coating layer to the positive electrode substrate caused a significant reduction in the intrinsic strength of the positive electrode substrate. It is considered that the crack caused a significant reduction in the current collectivity of the positive electrode substrate and a reduction in active-material utilization ratio.

In the battery in which the proportion of the nickel coating layer to the positive electrode substrate was adjusted to 27 wt %, on the other hand, a sufficient current collectivity could not be obtained conceivably because the excessively reduced proportion of the nickel coating layer (conversely, the excessively increased proportion of the foamed polypropylene) increased the electric resistance of the positive electrode substrate so that the charge/discharge efficiency was slightly inferior.

Next, a long-term charge/discharge cycle test (500 cycles) was performed with respect to each of the five types of alkaline storage batteries in the same manner as in Example 1. Then, the active-material utilization ratio (active-material utilization ratio after 500 cycles) was calculated for each of the five types of alkaline storage batteries. The results are shown by the marks x in FIG. 2. As shown in FIG. 2, in the battery in which the proportion of the nickel coating layer to the positive electrode substrate was adjusted to 27 wt %, the active-material utilization ratio after 500 cycles lowered to 83.1%. In the battery in which the proportion of the nickel coating layer to the positive electrode substrate was adjusted to 84 wt %, the active-material utilization ratio after 500 cycles further lowered to 80.7%.

By contrast, in the batteries in which the proportions of the nickel coating layers to the positive electrode substrates were adjusted to 30 wt %, 60 wt %, and 80 wt %, the active-material utilization ratios after 500 cycles lowered from the active-material utilization ratios after initial charging and discharging but still showed high values of about 90% (specifically, 90.2%, 90.5%, and 90.1% in this order).

From the result, it was found that, even when the average thickness of the nickel coating layer of the positive electrode substrate is adjusted to be not less than 0.5 μm and not more than 5 μm, the current collectivity of the positive electrode substrate and the charge/discharge efficiency of the battery cannot be held excellent over a long period of time unless the proportion of the nickel coating layer to the positive electrode substrate is adjusted to be not less than 30 wt % and not more than 80 wt %. Therefore, it can be said that, by adjusting the average thickness of the nickel coating layer of the positive electrode substrate to a value of not less than 0.5 μm and not more than 5 μm and also adjusting the proportion of the nickel coating layer to the positive electrode substrate to a value of not less than 30 wt % and not more than 80 wt %, it becomes possible to hold each of the current collectivity of the positive electrode substrate and the charge/discharge efficiency of the battery excellent over a long period of time.

### Example 4

In Example 4, five types of nickel-coated resin substrates in which the proportions of the nickel coating layers to the entire substrates were different (i.e., the thicknesses of the nickel coating layers were different) were produced in Step 1 by varying the respective composition concentrations of the nickel plating solutions and the immersion times for foamed polypropylene which is equal to that used in Example 1. As a result of examining the proportions of the nickel coating layers to the entire substrates in the five types of nickel-coated resin substrates in the same manner as in Example 1, each of them was in a range of not less than 30 wt % and not more than 80 wt %. As result of examining the average thickness of the nickel coating layers in the same manner as in Example 1, each of them was in a range not less than 0.5 μm and not more than 5 μm.

Subsequently, five types of nickel positive electrodes were produced in the same manner as in Steps 2 and 3 of Example 1. In Example 4, however, the theoretical capacities of the positive electrodes were varied in the range of 1100 mAh to 1400 mAh by adjusting the filling amounts of the positive electrode active material to a range of not less than 2 times and not more than 11 times the weights of the positive electrode substrates, unlike in Example 1. Specifically, the theoretical capacities of the positive electrodes were adjusted to 1100 mAh, 1200 mAh, 1300 mAh, 1350 mAh, and 1400 mAh by adjusting the filling amounts of the positive electrode active material to 2 times, 3 times, 7 times, 10 times, and 11 times the weights of the positive electrode substrates. Thereafter, five types of cylindrical closed nickel-metal hydride storage batteries each of the AA size were produced in the same manner as in Step 4 of Example 1.

(Evaluation of Battery Characteristics)

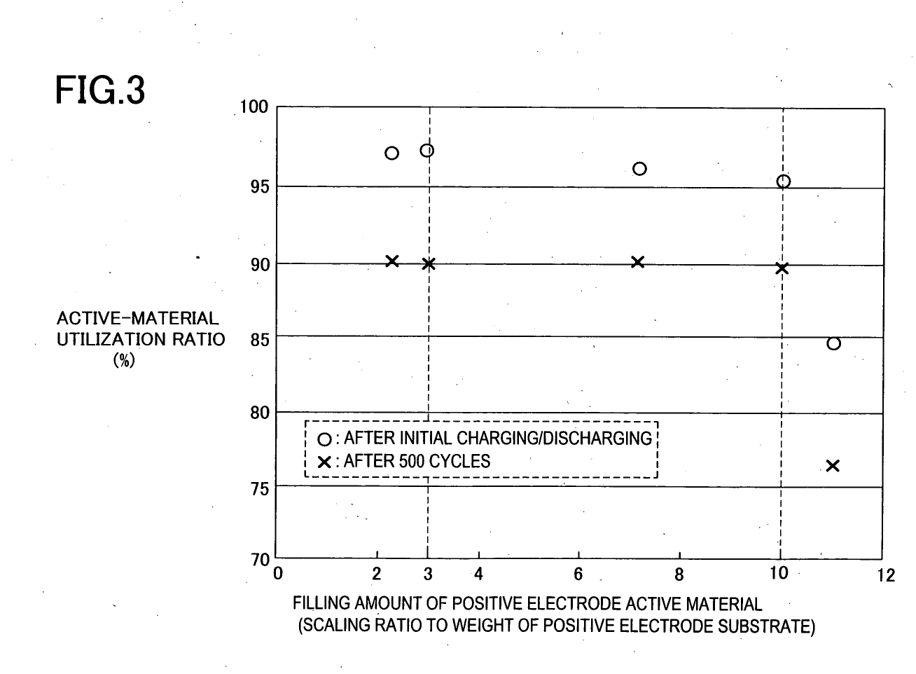

Next, characteristic evaluation was performed with respect to each of the five types of alkaline storage batteries according to Example 4. First, an initial charge/discharge cycle test was performed with respect to each of the five types of alkaline storage batteries in the same manner as in Example 1. It is to be noted that the current values at 1 C are different in the five types of alkaline storage batteries according to Example 4 since the theoretical capacities thereof are different from each other. Then, the active-material utilization ratio (active-material utilization ratio after initial charging and discharging) was calculated for each of the five types of alkaline storage batteries. The results are shown by the marks ∘ in FIG. 3. As shown in FIG. 3, in the batteries in which the filling amounts of the positive electrode active material were adjusted to 2 times, 3 times, 7 times, and 10 times the weights of the positive electrode substrates, the active-material utilization ratios became 95% or more (specifically, 96.5%, 96.5%, 96.1%, and 95.2% in this order) so that the excellent charge/discharge efficiencies were obtainable.

By contrast, in the battery in which the filling amount of the positive electrode active material was adjusted to 11 times the weight of the positive electrode substrate, the active-material utilization ratio became 84.7%, which was lower by 10% or more than the active-material utilization ratios of the other batteries. This is conceivably because, as a result of excessively increasing the filling amount of the positive electrode active material, the proportion of the nickel coating layer to the positive electrode active material was excessively reduced so that the current collectivity greatly lowered.

Next, a long-term charge/discharge cycle test (500 cycles) was performed with respect to each of the five types of alkaline storage batteries in the same manner as in Example 1. Then, the active-material utilization ratio (active-material utilization ratio after 500 cycles) was calculated for each of the five types of alkaline storage batteries. The results are shown by the marks x in FIG. 3. As shown in FIG. 3, in the battery in which the filling amount of the positive electrode active material was adjusted to 11 times the weight of the positive electrode substrate, the active-material utilization ratio after 500 cycles lowered to 76.8%.

By contrast, in the batteries in which the filling amounts of the positive electrode active material were adjusted to 2 times, 3 times, 7 times, and 10 times the weights of the positive electrode substrates, the active-material utilization ratios after 500 cycles lowered from the active-material utilization ratios after initial charging and discharging but still showed high values of about 90% (specifically, 90.1%, 90%, 89.7%, and 89.4% in this order). Therefore, it can be said that each of the batteries in which the filling amounts of the positive electrode active material were adjusted to 2 times to 10 times the weights of the positive electrode substrates retained an excellent charge/discharge efficiency over a long period of time.

Of the batteries each of which retained an excellent charge/discharge efficiency over a long period of time, the battery in which the filling amount of the positive electrode active material was adjusted to 2 times the weight of the positive electrode substrate had a battery capacity (theoretical capacity of the positive electrode) which was as small as 1100 mAh. By contrast, in the batteries in which the filling amounts of the positive electrode active material were adjusted to 3 times, 7 times, and 10 times the weights of the positive electrode substrates, the battery capacities (theoretical capacities of the positive electrodes) could be increased to the relatively large values of 1200 mAh, 1300 mAh, and 1350 mAh.

From the foregoing result, it can be said that, to adjust the battery capacity to a relatively large value and retain an excellent charge/discharge efficiency over a long period of time in the case of using the positive electrode substrate in which the average thickness of the nickel coating layer is adjusted to be not less than 0.5 μm and not more than 5 μm and the proportion of the nickel coating layer to the positive electrode substrate is adjusted to be not less than 30 wt % and not more than 80 wt %, the filling amount of the positive electrode active material should be adjusted to a value of not less than 3 times and not more than 10 times the weight of the positive electrode substrate. In other words, it can be said that, by filling the positive electrode substrate in which the average thickness of the nickel coating layer is adjusted to be not less than 0.5 μm and not more than 5 μm and the proportion of the nickel coating layer to the positive electrode substrate is adjusted to be not less than 30 wt % and not more than 80 wt % with the positive electrode active material in an amount within a range of not less than 3 times and not more than 10 times the weight of the positive electrode substrate, it becomes possible to adjust the battery capacity to a relatively large value and retain an excellent charge/discharge efficiency over a long period of time.

### Example 5

### Step 1: Production of Nickel-Coated Resin Substrate

First, a nickel-coated resin substrate comprising: a resin skeleton made of foamed polypropylene; and a nickel coating layer coating the resin skeleton and also having a void portion in which a plurality of pores are coupled in three dimensions was obtained by the same method as in Step 1 of Example 1. At this time, the proportion of the nickel coating layer to the entire nickel-coated resin substrate, which was calculated from a change in the weight of the actually obtained nickel-coated resin substrate, was 60 wt %. As a result of examining the average thickness of the nickel coating layer by observing an enlarged image of the rupture cross section of the nickel-coated resin substrate by using a SEM (scanning electron microscope), it was 1.5 μm.

### Step 2: Production of Positive Electrode Active Material

Next, nickel hydroxide powder having an average particle diameter of 10 μm was obtained as a positive electrode active material by the same method as in Step 2 of Example 1. As a result of performing composition analysis with respect to the obtained nickel hydroxide powder, the proportion of magnesium to all the metal elements (nickel and magnesium) contained in the nickel hydroxide particles was 5 mol % in the same manner as in the solution mixture used for synthesis. As a result of recording an X-ray diffraction pattern using a CuKα beam, it was recognized that each of the particles was composed of a β-Ni(OH)₂-type single-phase crystal. In other words, it was recognized that magnesium was solid-solved in the nickel hydroxide crystal.

### Step 3: Production of Nickel Positive Electrode

Next, a nickel positive electrode was produced. Specifically, the positive electrode active material powder obtained in Step 2 was mixed with metal cobalt powder, yttrium oxide powder, and zinc oxide powder and water was added thereto. The resulting mixture was kneaded into a paste. It is to be noted that the metal cobalt powder was added at a ratio of 5 parts by weight to 100 parts by weight of the positive electrode active material.

The paste was filled in the nickel-coated resin substrate obtained in Step 1, dried, and pressure-molded, whereby a nickel positive electrode board was produced. It is to be noted that a lead welding portion with no void portion was formed by rolling the portion of the nickel-coated resin substrate to which an electrode lead was to be welded later before the paste was filled. Since the void portion does not exist in the lead welding portion, the paste is prevented from being filled therein.

Then, the nickel positive electrode board was cut into a specified size and the electrode lead was bonded to the lead welding portion by ultrasonic welding so that the nickel positive electrode with a theoretical capacity of 1300 mAh was obtainable. The theoretical capacity of the nickel positive electrode was calculated by assuming that nickel in the active material underwent a single-electron reaction. It is also assumed that, in Example 5, the lead welding portion (the portion in which the positive electrode active material was not filled) is excluded from the nickel positive electrode and that the nickel-coated resin substrate included in the nickel positive electrode is the positive electrode substrate. Accordingly, the proportion of the nickel coating layer to the positive electrode substrate is 60 wt %, which is the same as the proportion of the nickel coating layer to the nickel-coated resin substrate. From the nickel positive electrode, the positive electrode active material powder, the metal cobalt powder, the yttrium oxide powder, and the zinc oxide powder were removed and the pore diameter distribution in the positive electrode substrate was measured by using a mercury porosimeter (Auto Pore III 9410 commercially available from Shimadzu Corporation). Based on the pore diameter distribution, the average pore diameter of the positive electrode substrate according to Example 5 was calculated to be 160 μm.

### Step 4: Production of Alkali Storage Battery

Next, a negative electrode with a capacity of 2000 mAh was obtained by the same method as in Step 4 of Example 1. Then, the negative electrode and the nickel positive electrode produced in Step 3 described above were rolled up with a separator composed of a sulfonated polypropylene non-woven fabric having a thickness of 0.15 mm interposed therebetween, thereby forming spiral electrodes. Subsequently, the electrodes were inserted into a bottomed cylindrical battery container made of a metal, which had been prepared separately, and 2.2 ml of a 7 mol/l aqueous potassium hydroxide solution was injected therein. Thereafter, the opening of the battery container was tightly closed with a sealing plate having a safety valve with a working pressure of 2.0 MPa, whereby a cylindrical closed nickel-metal hydride storage battery of the AA size was produced.

### Example 6

Compared with the alkaline storage battery according to Example 5, an alkaline storage battery according to Example 6 is different in the nickel positive electrode therefrom and otherwise the same.

Specifically, in Step 3, a powder of cobalt oxyhydroxide having a γ-type crystal structure (hereinafter also shown as γ-CoOOH) was added instead of the metal cobalt powder added in Example 5. The γ-CoOOH powder was added in an amount at a ratio of 5 parts by weight to 100 parts by weight of the positive electrode active material, similarly to the metal cobalt powder added in Example 5.

A cylindrical closed nickel-metal hydride storage battery of the AA size was produced in otherwise the same manner as in Example 5. In Example 6 also, the theoretical capacity of the positive electrode is assumed to be 1300 mAh in the same manner as in Example 5. The proportion of the nickel coating layer to the positive electrode substrate was adjusted to 60 wt % in the same manner as in Example 5.

### Example 7

Compared with the alkaline storage battery according to Example 6, an alkaline storage battery according to Example 7 is different in the nickel positive electrode therefrom and otherwise the same. More specifically, the two alkaline storage batteries are the same in that γ-CoOOH was caused to be contained in the nickel positive electrodes in Step 3 but are different in the forms in which γ-CoOOH was contained. A detailed description will be given to Step 3 of Example 7.

First, an aqueous solution (suspension) of the positive electrode active material (nickel hydroxide particles) obtained in Step 2 was produced. Then, an aqueous cobalt sulfate solution and an aqueous sodium hydroxide solution were supplied into the aqueous solution (suspension) such that the pH was maintained at 12.5. By thus precipitating cobalt hydroxide on the surfaces of the nickel hydroxide particles, the positive electrode active material coated with cobalt hydroxide (nickel hydroxide particles coated with cobalt hydroxide) was obtained. In Example 7, an amount of coating cobalt hydroxide was adjusted to be at a ratio of 5 parts by weight to 100 parts by weight of the positive electrode active material (nickel hydroxide particles).

Then, impurities such as sulfuric acid ions were removed by performing an alkali treatment using an aqueous sodium hydroxide solution at the pH of 13 to 14 with respect to the positive electrode active material coated with the cobalt compound. Thereafter, the positive electrode active material coated with the cobalt compound was washed with water and dried. In this manner, the positive electrode active material coated with cobalt hydroxide having an average particle diameter of 10 μm could be obtained. By adjusting conditions for the alkali treatment and washing with water, an amount of the sulfuric acid ions (sulfate group) and an amount of sodium ions each contained in the positive electrode active material coated with cobalt hydroxide were adjusted.

Then, a modification treatment was performed with respect to the positive electrode active material coated with cobalt hydroxide as follows. First, the powder of the positive electrode active material coated with cobalt hydroxide was impregnated with 40 wt % of an aqueous sodium hydroxide solution as an oxidation adjuvant. Thereafter, the powder was loaded in a drier having a microwave heating function and heated to be completely dried, while oxygen was supplied into the drier. As a result, the cobalt hydroxide coating layer on the surface of the positive electrode active material (nickel hydroxide particles) was oxidized and changed into indigo color. Subsequently, the obtained powder was washed with water and vacuum dried.

By iodometry, the total valence of all the metals in the obtained powder was determined and the average valence of cobalt was calculated based on the value of the total valence to be 3.1. As a result of performing composition analysis with respect to the obtained powder, it was found that sodium was contained in the coating layer. As a result of further measuring the conductivity of the powder in a state pressured at 39.2 MPa (400 kgf/cm²), it exhibited a high conductivity of 4.5×10⁻² S/cm.

Then, X-ray diffraction measurement using a CuKα beam was performed to examine the crystal structure of the cobalt compound forming the coating layer. However, because the coating layer had an extremely small thickness on the submicron order and the cobalt compound forming the coating layer had a low crystallinity, a peak showing the crystal structure of the cobalt compound could not be detected (specifically, the peak was hidden in a peak showing the crystal structure of nickel hydroxide). Consequently, the crystal structure of the cobalt compound layer could not be specified.

Under this situation, another cobalt hydroxide powder was prepared and a modification treatment was performed with respect to the cobalt hydroxide powder by the same method as described above. In this manner, cobalt compound powder equal to the cobalt compound layer formed on the surface of the positive electrode active material was obtained. Thereafter, X-ray diffraction measurement using a CuKα beam was performed with respect to the cobalt compound powder to examine the crystal structure thereof. As a result, it was found that the cobalt compound powder was cobalt oxyhydroxide having a γ-type crystal structure (γ-CoOOH). Accordingly, it was found that the cobalt compound layer formed on the surface of the positive electrode active material (nickel hydroxide particles) was cobalt oxyhydroxide (γ-CoOOH) having a γ-type crystal structure.

A cylindrical closed nickel-metal hydride storage battery of the AA size was produced in otherwise the same manner as in Example 6. In Example 7 also, the theoretical capacity of the positive electrode is assumed to be 1300 mAh in the same manner as in Examples 5 and 6. The proportion of the nickel coating layer to the positive electrode substrate was adjusted to 60 wt % in the same manner as in Examples 5 and 6.

### Comparative Example 2

Next, for comparison with Example 5 described above, an alkaline storage battery (Comparative Example 2) having a positive electrode substrate different from that used in Example 5 was produced. Specifically, in Step 1, a resin skeleton of a foamed polyurethane sheet was plated with nickel and then the resin skeleton was burned off, whereby a foamed nickel substrate was produced. The average thickness of the nickel skeleton of the foamed nickel substrate was 5.5 μm. Thereafter, a cylindrical closed nickel-metal hydride storage battery of the AA size was produced in the same manner as in Steps 2 to 4 of Example 5. In Comparative Example 2 also, the theoretical capacity of the positive electrode was assumed to be 1300 mA in the same manner as in Example 5.

### Comparative Example 3

Next, for comparison with Example 5 described above, an alkaline storage battery (Comparative Example 3) having a nickel positive electrode different from that used in Example 5 was produced. Specifically, cobalt monoxide powder was added in Step 3 instead of the metal cobalt powder added in Example 5. The cobalt monoxide powder was added in an amount at a ratio of 5 parts by weight to 100 parts by weight of the positive electrode active material, similarly to the metal cobalt powder added in Example 5. A cylindrical closed nickel-metal hydride storage battery of the AA size was produced in otherwise the same manner as in Example 5. In Comparative Example 3 also, the theoretical capacity of the positive electrode was assumed to be 1300 mA in the same manner as in Example 5.

(Evaluation of Battery Characteristics)

Next, characteristic evaluation was performed with respect to the respective alkaline storage batteries according to Examples 5 to 7 and Comparative Examples 2 and 3.

First, the charge/discharge efficiencies after an initial charge/discharge cycle were evaluated. Specifically, a charge/discharge cycle in which each of the batteries was charged with a current of 0.1 C at 20° C. for 15 hours and then discharged to release a current of 0.2 C till the battery voltage became 1.0 V was repeatedly performed till the discharge capacity was stabilized. Then, after the discharge capacity was stabilized, each of the batteries was charged with a current of 1 C at 20° C. for 1.2 hours and then discharged to release a current of 1 C till the battery voltage became 0.8 V. Based on the discharge capacity at that time, an active-material utilization ratio A (utilization ratio during 1 C discharge) was calculated for each of the batteries. Since the theoretical capacity of each of the alkaline storage batteries according to Examples 5 to 7 and Comparative Examples 2 and 3 was 1300 mAh, 1 C=1.3 A was satisfied.

Subsequently, each of the batteries was charged with a current of 1 C at 20° C. for 1.2 hours and then discharged to release a current of 5 C till the battery voltage became 0.6 V. Based on the discharge capacity at that time, an active-material utilization ratio B (utilization ratio during 5 C discharge) was calculated for each of the batteries. The active-material utilization ratios A and B were calculated herein relative to a theoretical amount of electricity when nickel in the active material underwent a single-electron reaction. Specifically, the ratio of the discharge capacity to 1300 mAh as the theoretical capacity of the positive electrode was shown. As an index showing the high-rate discharge characteristic of each of the batteries, the ratio (B/A) of the active-material utilization ratio B to the active-material utilization ratio A×100(%) was calculated (hereinafter, the value will be referred to also as a high-rate discharge characteristic value).

Then, the charge/discharge efficiencies after a long-term charge/discharge cycle were evaluated. Specifically, a charge/discharge cycle in which each of the batteries was charged with a current of 1 C at 20° C. for 1.2 hours and then discharged to release a current of 1 C till the battery voltage became 0.8 V was performed 500 times. Thereafter, based on the discharge capacity in the 500-th cycle, an active-material utilization ratio C (active-material utilization ratio after 500 cycles) was calculated for each of the batteries. Based on the result of calculation, the ratio (C/A) of the active-material utilization ratio C to the active-material utilization ratio A×100(%) was calculated as an index showing the cycle lifetime characteristic of each of the batteries (hereinafter, the value will be referred to also as a cycle lifetime characteristic value). The active-material utilization ratio C was also calculated relative to a theoretical amount of electricity when nickel in the active material underwent a single-electron reaction. The results of the characteristic evaluation are shown in Table 1.

TABLE 1

| | High-Rate Discharge | Cycle Lifetime |
|---|---|---|
| | Characteristic Value | Characteristic Value |
| | (B/A) × 100 (%) | (C/A) × 100 (%) |
| Example 5 | 94.9 | 93.9 |
| Example 6 | 94.9 | 93.9 |
| Example 7 | 96.4 | 94.9 |
| Comparative Example 2 | 94.8 | 82.5 |
| Comparative Example 3 | 90.7 | 92.8 |

The results of the characteristic evaluation of the individual batteries will be comparatively examined herein below.

First, comparisons will be made among the high-rate discharge characteristic values (B/A)×100(%). The high-rate discharge characteristics of the alkaline storage batteries according to Examples 5 to 7 and Comparative Example 2 showed high values of 94.8 to 96.4% so that each of the alkaline storage batteries was excellent in high-rate discharge characteristic. By contrast, the high-rate discharge characteristic of the alkaline storage battery according to Comparative Example 3 showed a value of 90.7% and was inferior to that of each of the other batteries. This is conceivably related to the fact that cobalt monoxide having a low conductivity was contained in the alkaline storage battery according to Comparative Example 3, while metal cobalt or γ-CoOOH having a high conductivity was contained in the nickel positive electrode of each of the alkaline storage batteries according to Examples 5 to 7 and Comparative Example 2. Specifically, a conceivable reason for this is as follows.

There has conventionally been known an alkaline storage battery in which cobalt monoxide having a low conductivity is contained in the nickel positive electrode using the foamed nickel substrate. From the battery, however, a high-rate discharge characteristic equal to that obtained from a battery in which metal cobalt or γ-CoOOH having a high conductivity is contained has been obtainable. This is because, in the battery using a foamed nickel substrate, even when cobalt monoxide having a low conductivity was contained in the nickel positive electrode, cobalt monoxide could be changed to cobalt oxyhydroxide having a high conductivity by an oxidation reaction occurring in the initial charging process.

However, in the alkaline storage battery according to Comparative Example 3 in which cobalt monoxide was similarly contained, the high-rate discharge characteristic thereof was lower than that of each of the other batteries in which metal cobalt or γ-CoOOH was contained. This is conceivably because, in the alkaline storage battery according to Comparative Example 3, the nickel-coated resin substrate having the resin skeleton (positive electrode substrate having the resin skeleton and the nickel coating layer coating the resin skeleton) was used for the positive electrode substrate. Specifically, since the nickel-coated resin substrate has the resin skeleton, it has a lower intrinsic conductivity than the foamed nickel substrate. It is considered that, as a result, the oxidation reaction of cobalt monoxide is less likely to proceed in the charging process and cobalt oxyhydroxide having a high conductivity is less likely to be generated. Therefore, it is considered that the nickel positive electrode of the alkaline storage battery according to Comparative Example 3 was lower in current collectivity than the nickel positive electrodes of the other batteries and the high-rate discharge characteristic thereof was inferior.

Next, the alkaline storage batteries according to Examples 5 to 7 and comparative Example 2, which were excellent in high-rate discharge characteristic, will be comparatively examined. In each of the alkaline storage batteries according to Examples 5 to 7, the high-rate discharge characteristic value was equal to or more than that of the alkaline storage battery according to Comparative Example 2. From the result, it can be said that, even when the nickel-coated resin substrate having the resin skeleton (positive electrode substrate having the resin skeleton and the nickel coating layer coating the resin skeleton) is used for the positive electrode substrate, a high-rate discharge characteristic as excellent as or more excellent than that obtained when the foamed nickel substrate is used can be obtained. This is conceivably because, by causing the nickel positive electrode to contain at least either of metal cobalt and γ-CoOOH, a network with an excellent conductivity could be formed.

The alkaline storage batteries according to Examples 5 to 7 will further be comparatively examined.

First, a comparison will be made between the alkaline storage batteries according to Examples 5 and 6. The two batteries are different only in which one of metal cobalt and γ-CoOOH was contained in the nickel positive electrode and otherwise the same. As a result of making a comparison between the high-rate discharge characteristic values of the alkaline storage batteries according to Examples 5 and 6, they were equally 94.9%. From the result, it can be said that, whether metal cobalt or γ-CoOOH is contained in the nickel positive electrode, an equally excellent high-rate discharge characteristic is obtainable.

A comparison will be made next between the alkaline storage batteries according to Examples 6 and 7. Although the two batteries are the same in that γ-CoOOH was contained in each of the nickel positive electrodes thereof, they are different in the forms in which γ-CoOOH was contained and otherwise the same. Specifically, the surface of the positive electrode active material (nickel hydroxide particles) was coated with γ-CoOOH in Example 7, while the powder of γ-CoOOH was simply mixed with the positive electrode active material (nickel hydroxide particles) and caused to be contained in the nickel positive electrode in Example 6.

As a result of making a comparison between the high-rate discharge characteristic values of the alkaline storage batteries according to Examples 6 and 7, a high-rate discharge characteristic value of 96.4% was shown in Example 7, which is higher than in Example 6 (94.9%). That is, in the alkaline storage battery according to Example 7, the high-rate discharge characteristic more excellent than in the alkaline storage battery according to Example 6 could be obtained. This is conceivably because, by coating the surface of the positive electrode active material (nickel hydroxide particles) with γ-CoOOH, γ-CoOOH could be uniformly distributed within the nickel positive electrode and the current collectivity of the nickel positive electrode could further be improved.

Next, comparisons will be made among the cycle lifetime characteristic values (C/A)×100(%) of the alkaline storage batteries according to Examples 5 to 7 and Comparative Examples 2 and 3. The cycle lifetime characteristics of the alkaline storage batteries according to Examples 5 to 7 and Comparative Example 3 showed high values of 92.8 to 94.9% so that each of the alkaline storage batteries was excellent in cycle lifetime characteristic. By contrast, the cycle lifetime characteristic of the alkaline storage battery according to Comparative Example 2 showed a low value of 82.5% and was considerably inferior to that of each of the other batteries.

After the cycle charge/discharge test, each of the batteries was disassembled and examined with the result that the nickel positive electrode of the alkaline storage battery according to Comparative Example 2 had a thickness 10% larger than that prior to charging and discharging. This is conceivably because the foamed nickel substrate was greatly enlarged forcibly by the expansion of the positive electrode active material (nickel hydroxide particles) resulting from charging and discharging so that the nickel positive electrode expanded. As a result, the separator was compressed, the electrolyte in the separator was significantly reduced, and the internal resistance was significantly increased. This may be a conceivable cause of the degraded cycle lifetime characteristic.

By contrast, in each of the alkaline storage batteries according to Examples 5 to 7 and Comparative Example 3, the positive electrode hardly expanded, the electrolyte in the separator was hardly reduced, and the internal resistance was also hardly increased. A conceivable reason for this is that, since the positive electrode substrate had the resin skeleton in each of Examples 5 to 7 and Comparative Example 3, unlike in Comparative Example 2, the positive electrode substrate was solidified and the deformation caused by the expansion of the positive electrode active material (nickel hydroxide particles) resulting from charging and discharging could be suppressed.

Since the physical properties (such as elongation percentage and strength) of the resin forming the skeleton greatly differ from those of the nickel coating layer coating the resin in each of the positive electrode substrates according to Examples 5 to 7, when the expansion/contraction of the positive electrode substrate is significant, a crack may be formed in the nickel coating layer or the nickel coating layer may be delaminated. To circumvent such problems, the expansion/contraction of the positive electrode substrate is preferably suppressed maximally. However, a crystal of nickel hydroxide composing the positive electrode active material tends to suffer a change in the crystal structure thereof through charging and discharging and greatly expand.

However, in each of the nickel positive electrodes according to Examples 5 to 7, a crack or delamination was not observed in the nickel coating layer. A conceivable reason for this is that magnesium was contained in a solid solution state in the crystal of nickel hydroxide composing the positive electrode active material. It is considered that, as a result, a change in the crystal structure resulting from charging and discharging could be suppressed and the expansion of the crystal resulting from charging and discharging could be suppressed. Therefore, it is considered that the expansion of the positive electrode substrate resulting from charging and discharging could be suppressed and the nickel coating layer did not suffer a crack or delamination.

From the foregoing, it can be said that each of the alkaline storage batteries according to Examples 5 to 7 is excellent in high-rate discharge characteristic and also excellent in cycle lifetime characteristic. In addition, in each of the alkaline storage batteries according to Examples 5 to 7, the labor of burning off the resin skeleton of foamed polypropylene can be omitted and the average thickness of the nickel coating layer of the positive electrode substrate could also be reduced to 1.5 μm so that the cost was reduced.

### Example 8

In Example 8, five types of nickel-coated resin substrates in which the average thicknesses of the nickel coating layers were different were produced in Step 1 by varying the composition concentrations of nickel plating solutions and the immersion times for foamed polypropylene. For the five types of nickel-coated resin substrates, the average thicknesses of the nickel coating layers were examined to be 0.35 μm, 0.5 μm, 2 μm, 5 μm, and 7 μm. In Example 8, the proportion of the nickel coating layer to the entire substrate was adjusted for each of the nickel-coated resin substrates to a range of not less than 30 wt % and not more than 80 wt % by adjusting the thicknesses (numbers) of the skeletons of foamed polypropylene.

Then, five types of nickel positive electrodes were produced in the same manner as in Steps 2 and 3 of Example 5. In Example 8 also, the theoretical capacity of each of the positive electrodes was assumed to be 1300 mAh in the same manner as in Example 5. Thereafter, five types of cylindrical closed nickel-metal hydride storage batteries each of the AA size were produced in the same manner as in Step 4 of Example 5.

(Evaluation of Battery Characteristics)

Characteristic evaluation was performed with respect to each of the five types of alkaline storage batteries according to Example 8.

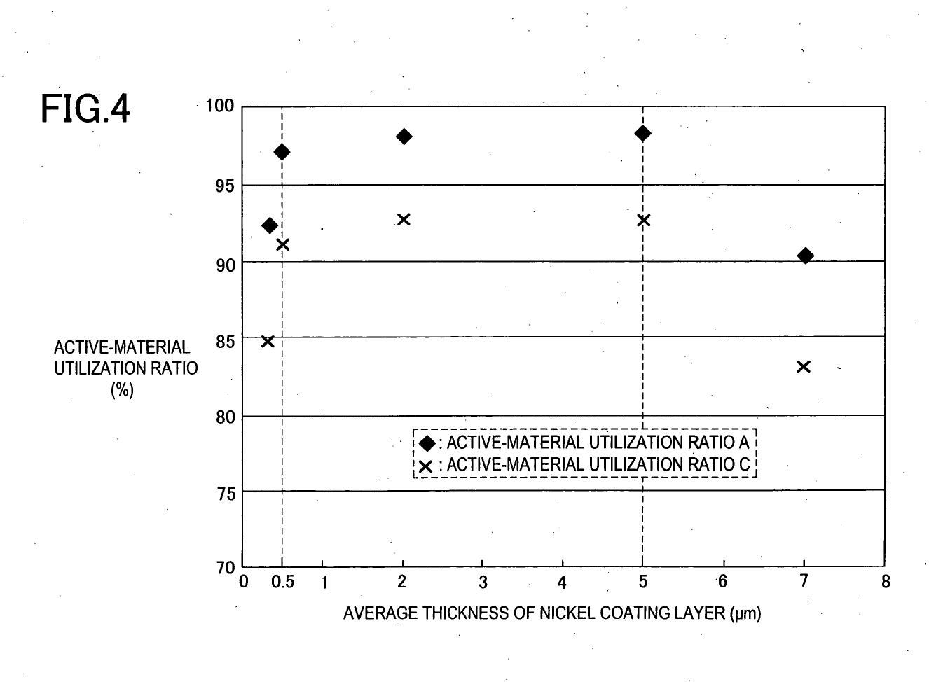

First, the initial charge/discharge cycle test was performed with respect to each of the five types of alkaline storage batteries in the same manner as in Example 5. Then, the active-material utilization ratio A (utilization ratio during 1 C discharge) was calculated for each of the five types of alkaline storage batteries. The results are shown by the marks ♦ in FIG. 4. As shown in FIG. 4, in the batteries in which the average thicknesses of the nickel coating layers were adjusted to 0.5 μm, 2 μm, and 5 μm, the active-material utilization ratio A became 95% or more (specifically, 97.2%, 98.1%, and 98.2% in this order) so that the excellent charge/discharge efficiencies were obtainable. By contrast, in the battery in which the average thickness of the nickel coating layer was adjusted to 0.35 μm, the active-material utilization ratio A became 92.4% so that the charge/discharge efficiency was slightly inferior. In the battery in which the average thickness of the nickel coating layer was adjusted to 7 μm, the active-material utilization ratio was 90.3%, which was the lowest.

After the initial charge/discharge cycle test, each of the batteries was disassembled and the SEM image of the cross section of each of the nickel positive electrodes was observed with the result that, in the battery in which the average thickness of the nickel coating layer was adjusted to 7 μm, a part of the nickel coating layer was delaminated from the positive electrode substrate. This may be a conceivable cause of the lowered active-material utilization ratio A. In the battery in which the average thickness of the nickel coating layer was adjusted to 0.35 μm, on the other hand, a sufficient current collectivity could not be obtained conceivably because the nickel coating layer was extremely thinned so that the charge/discharge efficiency was slightly inferior.

Next, a 500-cycle long-term charge/discharge cycle test was performed with respect to each of the five types of alkaline storage batteries in the same manner as in Example 5. Then, the active-material utilization ratio C (active-material utilization ratio after 500 cycles) was calculated for each of the five types of alkaline storage batteries. The results are shown by the marks x in FIG. 4. As shown in FIG. 4, in the battery in which the average thickness of the nickel coating layer was adjusted to 0.35 μm, the active-material utilization ratio after 500 cycles lowered to 84.9%. In the battery in which the average thickness of the nickel coating layer was adjusted to 7 μm, the active-material utilization ratio after 500 cycles further lowered to 82.9%.

By contrast, in the batteries in which the average thicknesses of the nickel coating layers were adjusted to 0.5 μm, 2 μm, and 5 μm, the active-material utilization ratios after 500 cycles lowered from the active-material utilization ratios after initial charging and discharging but still showed high values over 90% (specifically, 91.5%, 92.3%, and 92.5% in this order). From the result, it can be said that, by adjusting the average thickness of the nickel coating layer of the positive electrode substrate to a value of not less than 0.5 μm and not more than 5 μm, an excellent charge/discharge efficiency can be retained over a long period of time. It can also be said that the charge/discharge efficiency which had been held excellent over a long period of time indicates that the current collectivity of the positive electrode (positive electrode substrate) of the battery had been held excellent over a long period of time. Hence, it can be said that, by adjusting the average thickness of the nickel coating layer of the positive electrode substrate to a value of not less than 0.5 μm and not more than 5 μm, the current collectivity of the positive electrode substrate can be held excellent over a long period of time.

### Example 9

In Example 9, seven types of nickel positive electrodes which are different only in the contents of metal cobalt were produced in Step 3 by varying the amounts of metal cobalt added thereto. Specifically, metal cobalt powder was contained at ratios of 1 part by weight, 1.5 parts by weight, 2 parts by weight, 4 parts by weight, 6 parts by weight, 9 parts by weight, and 11 parts by weight to 100 parts by weight of the positive electrode active material (hereinafter the part or parts by weight of metal cobalt relative to 100 parts by weight of the positive electrode active material will be also termed simply as the part or parts by weight). Seven types of cylindrical closed nickel-metal hydride storage batteries each of the AA size were produced in otherwise the same manner as in Example 5.

(Evaluation of Battery Characteristics)

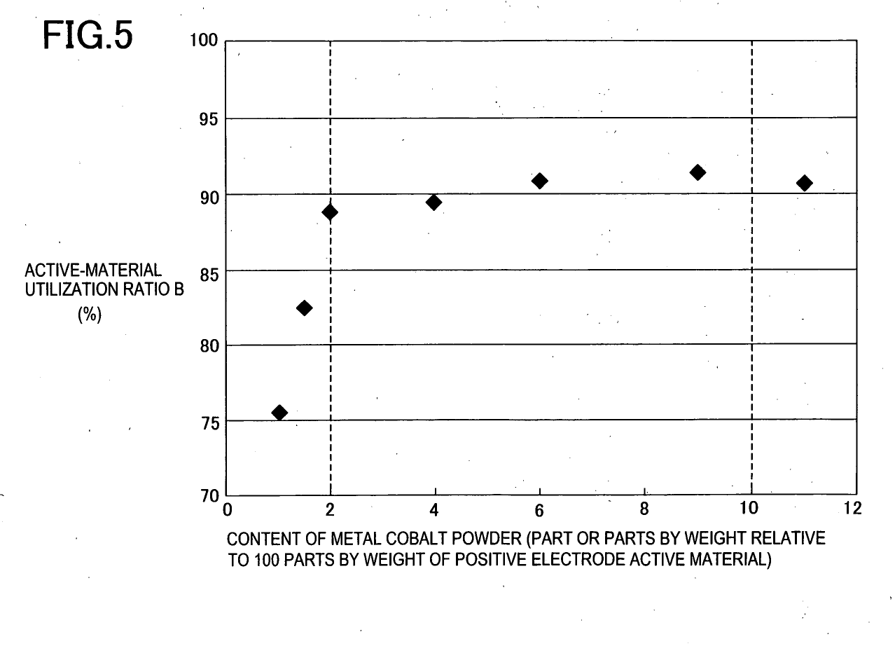

An initial charge/discharge cycle test was performed with respect to each of the seven types of alkaline storage batteries in the same manner as in Example 5. Then, the active-material utilization ratio B (utilization ratio after 5 C discharge) was calculated for each of the seven types of alkaline storage batteries according to Example 9. The results are shown by the marks ♦ in FIG. 5. As shown in FIG. 5, in the five types of batteries in which metal cobalt powder was contained at ratios of not less than 2 parts by weight, the active-material utilization ratio B had values of about 90% (specifically, 88.3%, 89.2%, 90.9%, 91.1%, and 90.3% in this order) so that the utilization ratios of the positive electrode active material in high-rate discharge was improved successfully.

By contrast, in the two types of batteries in which the metal cobalt powder was contained at ratios less than 2 parts by weight (specifically, 1 part by weight and 1.5 parts by weight), the active-material utilization ratio B had low values of 75.5% and 82.8%. As can be seen from FIG. 5, the active-material utilization ratio B greatly lowers when the amount of the metal cobalt powder is under 2 parts by weight. From the result, it can be said that, by adjusting the amount of the metal cobalt powder to a value of not less than 2 parts by weight, the utilization ratio of the positive electrode active material in high-rate discharge can be improved. This is conceivably because, by causing the nickel positive electrode to contain metal cobalt at a ratio of not less than 2 parts by weight to 100 parts by weight of the positive electrode active material, an excellent current collectivity can be obtained.

Of the five types batteries in each of which the utilization ratio of the positive electrode active material in high-rate discharge was excellent, each of the four types of batteries in which the metal cobalt powder was contained in amounts of not more than 10 parts by weight was allowed to have a relatively large battery capacity (theoretical capacity of the positive electrode) of about 1300 mAh. By contrast, the battery in which the metal cobalt powder was contained in an amount of 11 parts by weight had a small battery capacity (theoretical capacity of the positive electrode) of 1100 mAh. This is because, as the content of metal cobalt is increased, the filling amount of the positive electrode active material lowers and the capacity density of the positive electrode lowers accordingly. From the result, it can be said that, by adjusting the content of metal cobalt to a ratio of not more than 10 parts by weight to 100 parts by weight of the positive electrode active material, a relatively large battery capacity (theoretical capacity of the positive electrode) can be provided.

From the result, it can be said that the amount of metal cobalt to be contained in the nickel positive electrode is preferably adjusted to a ratio of 2 to 10 parts by weight to 100 parts by weight of the positive electrode active material.

Although Example 9 has caused the nickel positive electrode to contain the metal cobalt powder, it is also possible to cause the nickel positive electrode to contain γ-CoOOH instead of the metal cobalt powder. Even when the nickel positive electrode was caused to contain γ-CoOOH, the utilization ratio of the positive electrode active material in high-rate discharge could be improved by adjusting the amount of γ-CoOOH to be contained in the nickel positive electrode to a ratio of not less than 2 parts by weight to 100 parts by weight of the positive electrode active material. By adjusting the amount of γ-CoOOH to a ratio of not more than 10 parts by weight to 100 parts by weight of the positive electrode active material, a relatively large battery capacity (theoretical capacity of the positive electrode) (about 1300 mAh) could be provided. Therefore, it can be said that the amount of γ-CoOOH to be contained in the nickel positive electrode is preferably adjusted to a ratio of 2 to 10 parts by weight to 100 parts by weight of the positive electrode active material.

In this case, however, γ-CoOOH is contained more preferably in the form in which the surface of the positive electrode active material (nickel hydroxide particles) is coated with γ-CoOOH than in the form in which the powder of γ-CoOOH is simply mixed with the positive electrode active material (nickel hydroxide particles) and caused to be contained in the nickel positive electrode. This is because, by coating the surface of the positive electrode active material (nickel hydroxide particles) with γ-CoOOH, γ-CoOOH can be uniformly distributed within the nickel positive electrode and the current collectivity of the nickel positive electrode can further be improved.

### Example 10

### Step 1: Production of Nickel-Coated Resin Substrate

First, a non-woven fabric composed of a fiber mixture of a polypropylene fiber and a sheath-core type composite fiber (fiber composed of polypropylene as the core thereof and polyethylene as the sheath thereof) was prepared. Then, a known hydrophilic treatment for sulfonation using a fuming sulfuric acid was performed with respect to the non-woven fabric, thereby providing a sulfonated non-woven fiber. The non-woven fiber used in Example 10 was manufactured by a typical wet manufacturing method to have a unit weight of 100 g/m² and a thickness of 1 mm.

Then, an aqueous solution containing tin chloride and an aqueous solution containing palladium chloride were circulated in the sulfonated non-woven fabric so that the sulfonated non-woven fabric was catalyzed. Then, the sulfonated non-woven fabric that had been catalyzed was immersed in a nickel plating solution containing nickel sulfate, sodium citrate, hydrated hydradine as a reductant, and ammonia as a pH adjustor and, in this state, the nickel plating solution was heated to 80° C. and circulated. In this manner, nickel electroless plating was performed with respect to the sulfonated non-woven fabric. The respective composition concentrations of the nickel plating solution and the immersion time were adjusted such that the proportion of the weight of the nickel plate to that of the substrate after plating was 57 wt %.

Subsequently, after the plating solution became substantially transparent, the substrate with a nickel coating layer was washed with water and then dried. Thus, a nickel-coated resin substrate comprising: a resin skeleton composed of the sulfonated non-woven fabric; and the nickel coating layer coating the resin skeleton and also having the void portion in which a plurality of pores are coupled in three dimensions could be obtained. At this time, the proportion of the nickel coating layer to the entire nickel-coated resin substrate, which was calculated from a change in the weight of the actually obtained nickel-coated resin substrate, was 55 wt %. As a result of examining the average thickness of the nickel coating layer by observing an enlarged image of the rupture cross section of the nickel-coated resin substrate by using a SEM (scanning electron microscope), it was 2 μm.

### Step 2: Production of Positive Electrode Active Material

Next, nickel hydroxide powder having an average particle diameter of 10 μm was obtained as a positive electrode active material by the same method as in Step 2 of Example 1. As a result of performing composition analysis with respect to the obtained nickel hydroxide powder by ICP emission analysis, the proportion of magnesium to all the metal elements (nickel and magnesium) contained in the nickel hydroxide particles was 5 mol % in the same manner as in the solution mixture used for synthesis. As a result of recording an X-ray diffraction pattern using a CuKα beam, it was recognized that each of the particles was composed of a β-type Ni(OH)₂. It was also recognized that, since a peak showing the presence of an impurity was not observed, magnesium was solid-solved in the nickel hydroxide crystal.

### Step 3: Production of Cobalt Oxyhydroxide Having β-Type Crystal Structure)

Next, cobalt oxyhydroxide having a β-type crystal structure (hereinafter also shown as β-CoOOH) was produced. First, each of an aqueous cobalt sulfate solution, an aqueous sodium hydroxide solution, and an aqueous ammonia solution was supplied continuously at a constant flow rate into a reaction vessel. Then, the oxidation of cobalt contained in an aqueous solution in the reaction vessel was promoted by supplying air at a constant flow rate into the aqueous solution in the reaction vessel, while continuously agitating the aqueous solution. Then, a suspension was collected from the reaction vessel through overflow and a precipitate was separated by decantation. Thereafter, the precipitate was washed with water and dried so that powder having an average particle diameter of 3 μm was obtainable.

Subsequently, X-ray diffraction measurement using a CuKα beam was performed with respect to the obtained powder, thereby examining the crystal structure thereof. As a result of examining an X-ray diffraction pattern, a peak belonging to β-type cobalt oxyhydroxide could be recognized. From the result, it was found that the obtained powder was of cobalt oxyhydroxide having a β-type crystal structure (β-CoOOH).

ICP emission analysis and oxidation-reduction titration were performed with respect to the β-CoOOH powder. Based on the results, the average valence of cobalt contained in β-CoOOH was calculated to be 2.95.

### Step 4: Production of Nickel Positive Electrode

Next, a nickel positive electrode was produced. Specifically, the positive electrode active material powder obtained in Step 2 was mixed with the β-CoOOH powder obtained in Step 3, metal cobalt powder, yttrium oxide powder, and zinc oxide powder and water was added thereto. The resulting mixture was kneaded into a paste. It is to be noted that each of the metal cobalt powder and the β-CoOOH powder was added at a ratio of 4 parts by weight to 100 parts by weight of the positive electrode active material. On the other hand, each of the yttrium oxide powder and the zinc oxide powder was added at a ratio of 1 part by weight to 100 parts by weight of the positive electrode active material.

The paste was filled in the nickel-coated resin substrate obtained in Step 1, dried, and pressure-molded, whereby a nickel positive electrode board was produced. It is to be noted that a lead welding portion with no void portion was formed by rolling the portion of the nickel-coated resin substrate to which an electrode lead was to be welded later before the paste was filled. Since the void portion does not exist in the lead welding portion, the paste is prevented from being filled therein.

Then, the nickel positive electrode board was cut into a specified size and the electrode lead was bonded to the lead welding portion by ultrasonic welding so that the nickel positive electrode with a theoretical capacity of 1300 mAh was obtainable. The theoretical capacity of the nickel positive electrode was calculated by assuming that the nickel in the active material underwent a single-electron reaction. It is also assumed that, in Example 10, the lead welding portion (the portion in which the positive electrode active material was not filled) is excluded from the nickel positive electrode and that the nickel-coated resin substrate included in the nickel positive electrode is the positive electrode substrate. Accordingly, the proportion of the nickel coating layer to the positive electrode substrate is 55 wt %, which is the same as the proportion of the nickel coating layer to the nickel-coated resin substrate.

From the nickel positive electrode, the positive electrode active material powder, the metal cobalt powder, the β-CoOOH powder, the yttrium oxide powder, and the zinc oxide powder were removed and the pore diameter distribution in the positive electrode substrate was measured by using a mercury porosimeter (Auto Pore III 9410 commercially available from Shimadzu Corporation). Based on the pore diameter distribution, the average pore diameter of the positive electrode substrate according to Example 10 was calculated to be 30 μm.

### Step 5: Production of Alkali Storage Battery

Next, a negative electrode with a capacity of 2000 mAh was obtained by the same method as in Step 4 of Example 1. Then, the negative electrode and the nickel positive electrode produced in Step 4 described above were rolled up with a separator composed of a sulfonated polypropylene non-woven fabric having a thickness of 0.15 mm interposed therebetween, thereby forming spiral electrodes. Subsequently, the electrodes were inserted into a bottomed cylindrical battery container made of a metal, which had been prepared separately, and 2.2 ml of a 7 mol/l aqueous potassium hydroxide solution was injected therein. Thereafter, the opening of the battery container was tightly closed with a sealing plate having a safety valve with a working pressure of 2.0 MPa, whereby a cylindrical closed nickel-metal hydride storage battery of the AA size was produced.

### Example 11

Compared with the alkaline storage battery according to Example 10, an alkaline storage battery according to Example 11 is different in the nickel positive electrode therefrom and otherwise the same. More specifically, the two alkaline storage batteries are the same in that β-CoOOH was contained in the nickel positive electrodes but are different in the forms in which β-CoOOH is contained. A detailed description will be given, while placing emphasis on a difference with Example 10.

First, a nickel-coated resin substrate and a positive electrode active material (nickel hydroxide particles) were produced in Steps 1 and 2 in the same manner as in Example 10.

Then, in Step 3, a positive electrode active material coated with β-CoOOH was produced by coating the surface of the positive electrode active material (nickel hydroxide particles) with β-CoOOH, unlike in Example 10.

Specifically, an aqueous solution (suspension) of the positive electrode active material (nickel hydroxide particles) obtained in Step 2 was produced first. Then, an aqueous cobalt sulfate solution, an aqueous sodium hydroxide solution, and an aqueous ammonia solution were supplied into the aqueous solution (suspension), while air was also supplied. By thus precipitating cobalt oxyhydroxide on the surfaces of the nickel hydroxide particles, the positive electrode active material coated with cobalt oxyhydroxide (nickel hydroxide particles coated with cobalt oxyhydroxide) was obtained. In Example 11, an amount of coating cobalt oxyhydroxide was adjusted to be at a ratio of 4 parts by weight to 100 parts by weight of the positive electrode active material (nickel hydroxide particles). Thereafter, the obtained positive electrode active material coated with cobalt oxyhydroxide was washed with water and dried. In this manner, the positive electrode active material coated with cobalt oxyhydroxide having an average particle diameter of 10 μm could be obtained.

Then, ICP emission analysis and oxidation-reduction titration were performed with respect to the obtained positive electrode active material coated with cobalt oxyhydroxide. Based on the results, the average valence of cobalt contained in the coating layer of cobalt oxyhydroxide was calculated to be 2.92.

In addition, X-ray diffraction measurement using a CuKα beam was performed to examine the crystal structure of cobalt oxyhydroxide forming the coating layer. As a result of examining an X-ray diffraction pattern from the positive electrode active material coated with cobalt oxyhydroxide, a peak belonging to β-type nickel hydroxide and a peak belonging to β-type cobalt oxyhydroxide could be recognized. From the result, it was found that cobalt oxyhydroxide forming the coating layer was cobalt oxyhydroxide having a β-type crystal structure (β-CoOOH).

Next, in Step 4, β-CoOOH was added in the form in which the positive electrode active material (nickel hydroxide particles) was coated with β-CoOOH as described above (i.e., positive electrode active material coated with β-CoOOH) without additionally adding the β-CoOOH powder, unlike in Example 10.

A cylindrical closed nickel-metal hydride storage battery of the AA size was produced in otherwise the same manner as in Example 10. In Example 11 also, the theoretical capacity of the positive electrode is assumed to be 1300 mAh in the same manner in Example 10. The proportion of the nickel coating layer to the positive electrode substrate was adjusted to 55 wt % in the same manner as in Example 10.

### Comparative Example 4

Next, for comparison with Example 10 described above, an alkaline storage battery (Comparative Example 4) having a positive electrode substrate different from that used in Example 10 was produced. Specifically, in Step 1, a resin skeleton composed of a foamed polyurethane sheet was plated with nickel and then the resin skeleton was burned off, whereby a foamed nickel substrate was produced. The average thickness of the nickel skeleton of the foamed nickel substrate was 5.5 μm. Thereafter, a cylindrical closed nickel-metal hydride storage battery of the AA size was produced in the same manner as in Steps 2 to 4 of Example 10. In Comparative Example 4 also, the theoretical capacity of the positive electrode was assumed to be 1300 mA in the same manner as in Example 10.

### Comparative Example 5

Next, for comparison with Example 10 described above, an alkaline storage battery (Comparative Example 5) having a nickel positive electrode different from that used in Example 10 was produced. Specifically, cobalt monoxide powder was added in Step 4 instead of the metal cobalt powder and the β-CoOOH powder added in Example 10. The cobalt monoxide powder was added in an amount at a ratio of 8 parts by weight to 100 parts by weight of the positive electrode active material such that the added amount thereof was equal to the total amount of the metal cobalt powder and the β-CoOOH powder added in Example 10. A cylindrical closed nickel-metal hydride storage battery of the AA size was produced in otherwise the same manner as in Example 10. In Comparative Example 5 also, the theoretical capacity of the positive electrode was assumed to be 1300 mA in the same manner as in Example 10.

### Comparative Example 6

Next, for comparison with Example 10 described above, an alkaline storage battery (Comparative Example 6) also having a nickel positive electrode different from that used in Example 10 was produced. Specifically, in Step 4, the β-CoOOH powder was added at a ratio of 8 parts by weight to 100 parts by weight of the positive electrode active material without adding the metal cobalt powder. A cylindrical closed nickel-metal hydride storage battery of the AA size was produced in otherwise the same manner as in Example 10. In Comparative Example 6 also, the theoretical capacity of the positive electrode was assumed to be 1300 mA in the same manner as in Example 10.

### Comparative Example 7

Next, for comparison with Example 10 described above, an alkaline storage battery (Comparative Example 7) also having a nickel positive electrode different from that used in Example 10 was produced. Specifically, in Step 4, the metal cobalt powder was added at a ratio of 8 parts by weight to 100 parts by weight of the positive electrode active material without adding the β-CoOOH powder. A cylindrical closed nickel-metal hydride storage battery of the AA size was produced in otherwise the same manner as in Example 10. In Comparative Example 7 also, the theoretical capacity of the positive electrode was assumed to be 1300 mA in the same manner as in Example 10.

(Evaluation of Battery Characteristics)

Next, characteristic evaluation was performed with respect to the respective alkaline storage batteries according to Examples 10 and 11 and Comparative Examples 4 to 7.

First, the charge/discharge efficiencies after an initial charge/discharge cycle were evaluated. Specifically, the active-material utilization ratios A and B were calculated for each of the batteries in the same manner as in Example 5. Further, as an index showing the high-rate discharge characteristic of each of the batteries, the ratio (B/A) of the active-material utilization ratio B to the active-material utilization ratio A×100(%) (high-rate discharge characteristic value) was calculated.

Then, at a high temperature of 60° C., each of the batteries was charged with a current of 1 C for 1.2 hours and then discharged to release a current of 1 C at 20° C. till the battery voltage became 0.8 V. Based on the discharge capacity at that time, an active-material utilization ratio E was calculated for each of the batteries. Further, as an index showing the high-temperature charge characteristic of each of the batteries, the ratio (E/A) of the active-material utilization ratio E to the active-material utilization ratio A×100(%) was calculated (hereinafter, the value will be also referred to as a high-temperature charge characteristic value).

Then, the charge/discharge efficiencies after a long-term charge/discharge cycle were evaluated. Specifically, a charge/discharge cycle in which each of the batteries was charged with a current of 1 C at 20° C. for 1.2 hours and then discharged to release a current of 1 C till the battery voltage became 0.8 V was performed 1000 times. Thereafter, based on the discharge capacity in the 1000-th cycle, an active-material utilization ratio D was calculated for each of the batteries. Based on the result of calculation, the ratio (D/A) of the active-material utilization ratio D to the active-material utilization ratio A×100(%) was calculated as an index showing the cycle lifetime characteristic of each of the batteries (hereinafter, the value will be also referred to as a cycle lifetime characteristic value).

Each of the active-material utilization ratios A, B, D, and E was calculated relative to an theoretical amount of electricity when nickel in the active material underwent a single-electron reaction. It is to be noted that, in contrast to Examples 1 to 8 described above in each of which the 500 charge/discharge cycles were performed with respect to the batteries in the evaluation of the cycle lifetime characteristics thereof, as many as 1000 charge/discharge cycles were performed herein by adding another 500 cycles. The results of the characteristic evaluation are shown in Table 2.

TABLE 2

| | High-Rate | High-Temperature | |
|---|---|---|---|
| | Discharge | Charge | Cycle Lifetime |
| | Characteristic | Characteristic | Characteristic |
| | (B/A) × 100 (%) | (E/A) × 100 (%) | (D/A) × 100 (%) |
| Example 10 | 94.1 | 74.4 | 84.4 |
| Example 11 | 94.4 | 77.1 | 85.8 |
| Comparative | 93.9 | 77.7 | 62.4 |
| Example 4 | | | |
| Comparative | 91.2 | 62.7 | 67.7 |
| Example 5 | | | |
| Comparative | 87.3 | 69.9 | 72.8 |
| Example 6 | | | |
| Comparative | 95.3 | 66.7 | 69.1 |
| Example 7 | | | |

The results of the characteristic evaluation of the individual batteries will be comparatively examined herein below.

First, comparisons will be made among the high-rate discharge characteristic values (B/A)×100(%). The high-rate discharge characteristics of the alkaline storage batteries according to Examples 10 and 11 and Comparative Examples 4 and 7 showed high values of about 94% so that each of the alkaline storage batteries was excellent in high-rate discharge characteristic. By contrast, the high-rate discharge characteristic of the alkaline storage battery according to Comparative Example 5 showed a value of 91.2% and was inferior to that of each of the other batteries. Besides, the high-rate discharge characteristic of the alkaline storage battery according to Example 6 showed a value of 87.3% and was considerably inferior to that of each of the other batteries. This is conceivably because cobalt monoxide or β-CoOOH having a low conductivity was contained in each of the alkaline storage batteries according to Comparative Examples 5 and 6 without causing metal cobalt having a high conductivity to be contained, while metal cobalt was contained in the nickel positive electrode of each of the alkaline storage batteries according to Examples 10 and 11 and Comparative Examples 4 and 7.

There has conventionally been known an alkaline storage battery in which cobalt monoxide having a low conductivity is contained in the nickel positive electrode using the foamed nickel substrate. From the conventional battery, however, a high-rate discharge characteristic equal to that obtained from a battery in which metal cobalt having a high conductivity is contained has been obtainable. This is because, in the battery using a foamed nickel substrate, even when cobalt monoxide having a low conductivity was contained in the nickel positive electrode, cobalt monoxide could be changed to cobalt oxyhydroxide having a high conductivity by an oxidation reaction occurring in the initial charging process.

However, in the alkaline storage battery according to Comparative Example 5 in which cobalt monoxide was similarly contained, the high-rate discharge characteristic thereof was lower than that of each of the other batteries in which metal cobalt was contained. This is conceivably because, in the alkaline storage battery according to Comparative Example 5, the nickel-coated resin substrate having the resin skeleton (positive electrode substrate having the resin skeleton and the nickel coating layer coating the resin skeleton) was used for the positive electrode substrate. Specifically, since the nickel-coated resin substrate has the resin skeleton, it has a lower intrinsic conductivity than the foamed nickel substrate. It is considered that, as a result, the oxidation reaction of cobalt monoxide is less likely to proceed in the charging process and cobalt oxyhydroxide having a high conductivity is less likely to be generated. Therefore, it is considered that the nickel positive electrode of the alkaline storage battery according to Comparative Example 5 was lower in current collectivity than the nickel positive electrodes of the other batteries and the high-rate discharge characteristic thereof was inferior.

Next, the alkaline storage batteries according to Examples 10 and 11 and Comparative Examples 4 and 7, which were excellent in high-rate discharge characteristic, will be comparatively examined. These batteries had the greatly different positive electrode substrates. Specifically, each of the alkaline storage batteries according to Examples 10 and 11 and Comparative Example 7 used the nickel-coated resin substrate having the resin skeleton, while the alkaline storage battery according to Comparative Example 4 used the foamed nickel substrate not having the resin skeleton.

As described above, when the nickel-coated resin substrate having the resin skeleton was used in the positive electrode substrate of the conventional alkaline storage battery, there was the problem that the high-rate discharge characteristic thereof greatly lowered compared with the case where the foamed nickel substrate was used. However, the high-rate discharge characteristic value of each of the alkaline storage batteries (nickel-coated resin substrate) according to Examples 10 and 11 and Comparative Example 7 (nickel-coated resin substrate) was equal to or more excellent than that of the alkaline storage battery (formed nickel substrate) according to Comparative Example 4. From the result, it can be said that, even when the nickel-coated resin substrate having the resin skeleton (positive electrode substrate having the resin skeleton and the nickel coating layer coating the resin skeleton) is used, a high-rate discharge characteristic as excellent as or more excellent than that obtained in the case where the foamed nickel substrate is used can be obtained. This is conceivably because, by causing the nickel positive electrode to contain metal cobalt, a network with an excellent conductivity could be formed.

Next, comparisons will be made among the high-temperature charge characteristic values (E/A)×100(%) of the alkaline storage batteries according to Examples 10 and 11 and Comparative Examples 4 to 7. Each of these alkaline storage batteries showed a high-temperature charge characteristic value of not less than 62% so that each of them was relatively excellent in high-temperature charge characteristic. This is conceivably because the oxygen overvoltage could be increased by causing the nickel positive electrode to contain yttrium oxide and zinc oxide and hence the oxygen generating reaction during the final period of charging could be suppressed even in a high-temperature state (60° C.).

Among them, each the alkaline storage batteries according to Examples 10 and 11 and Comparative Example 4 had the high-temperature charge characteristic showing a value of not less than 74% so that each of them was more excellent in high-temperature charge characteristic than the alkaline storage batteries according to Comparative Examples 5 to 7 (each of which had the high-temperature charge characteristic value of 70% or less). This is conceivably because, by causing the nickel positive electrode to contain metal cobalt and β-CoOOH, the oxygen overvoltage during charging could be further increased. Accordingly, it can be considered that the oxygen generating reaction during the final period of charging could be further suppressed in a high-temperature state (60° C.).

Next, comparisons will be made among the cycle lifetime characteristic values (D/A)×100(%) of the alkaline storage batteries according to Examples 10 and 11 and Comparative Examples 4 to 7. The cycle lifetime characteristics values after 1000 cycles of the alkaline storage batteries according to Examples 10 and 11 showed high values of about 85% so that each of the alkaline storage batteries was excellent in cycle lifetime characteristic. By contrast, the cycle lifetime characteristics values of the alkaline storage batteries according to Comparative Examples 4 to 7 were 62.4%, 67.7%, 72.8%, and 69.1% so that the cycle lifetime characteristics thereof were considerably inferior to those of the alkaline storage batteries according to Examples 10 and 11.

After the cycle charge/discharge test, each of the batteries was disassembled and examined with the result that the nickel positive electrode of the alkaline storage battery according to Comparative Example 4 had a thickness 12% larger than that prior to charging and discharging. This is conceivably because the foamed nickel substrate was greatly enlarged forcibly by the expansion of the positive electrode active material (nickel hydroxide particles) resulting from charging and discharging so that the nickel positive electrode expanded. As a result, the separator was compressed, the electrolyte in the separator was significantly reduced, and the internal resistance was significantly increased. This may be a conceivable cause of the degraded cycle lifetime characteristic.

By contrast, in each of the alkaline storage batteries according to Examples 10 and 11 and Comparative Example 5 to 7, the degree of expansion of the positive electrode was lower than in Comparative Example 4. A conceivable reason for this is that, since the positive electrode substrate had the resin skeleton in each of Examples 10 and 11 and Comparative Examples 5 to 7, unlike in Comparative Example 4, the positive electrode substrate was solidified and the deformation caused by the expansion of the positive electrode active material (nickel hydroxide particles) resulting from charging and discharging could be suppressed.

However, in each of the alkaline storage batteries according to Comparative Examples 5 to 7, the corrosion (passivation by oxidation) of nickel forming the nickel positive electrode had proceeded and the electrolyte was significantly reduced. It is considered that these are the causes of the degraded cycle lifetime characteristic. A conceivable reason for this is as follows.

In each of the alkaline storage batteries according to Comparative Examples 5 to 7, the positive electrode substrate (nickel-coated resin substrate) could not be annealed at a high temperature in Step 1 because the resin skeleton was left in the positive electrode substrate. It is considered that, as a result, a crystal of nickel could not be grown sufficiently and the crystal size of nickel became small. When the crystal size of nickel is small, the corrosion (passivation by oxidation) of nickel tends to readily proceed under the influence of oxygen generated as a secondary reaction during the final period of charging. Therefore, it is considered that, in each of the alkaline storage batteries according to Comparative Examples 5 to 7, the corrosion of nickel proceeded with repeated charging and discharging and therefore the current collectivity of the positive electrode substrate was lowered, while the electrolyte was also significantly reduced.

However, in each of the alkaline storage batteries according to Examples 10 and 11, problems as described above did not occur regardless of the fact that the positive electrode substrate (nickel-coated resin substrate) equal to that used in each of the alkaline storage batteries according to Comparative Examples 5 to 7 was used therein. This is conceivably because, in each of Examples 10 and 11, cobalt oxyhydroxide having a β-type crystal structure was contained together with metal cobalt in the nickel positive electrode, unlike in Comparative Examples 5 to 7. In other words, it is considered that, by causing the nickel positive electrode to contain metal cobalt and cobalt oxyhydroxide having a β-type crystal structure, the oxygen overvoltage during charging could be increased. Therefore, it is considered that the arrangement allowed the suppression of the oxygen generating reaction during charging, the suppression of corrosion (passivation by oxidation) of nickel, and an improvement in cycle lifetime characteristic.

Since the physical properties (such as elongation percentage and strength) of the resin forming the skeleton greatly differ from those of the nickel coating layer coating the resin in each of the positive electrode substrates (nickel-coated resin substrates) used in the alkaline storage batteries according to Examples 10 and 11, when the expansion/contraction of the positive electrode substrate is significant, a crack may be formed in the nickel coating layer or the nickel coating layer may be delaminated. To circumvent such problems, the expansion/contraction of the positive electrode substrate is preferably suppressed maximally. However, a crystal of nickel hydroxide composing the positive electrode active material tends to suffer a change in the crystal structure thereof through charging and discharging and greatly expand.

However, in each of the alkaline storage batteries according to Examples 10 and 11, a crack or delamination was not observed in the nickel coating layer. A conceivable reason for this is that magnesium is contained in a solid solution state in the crystal of nickel hydroxide composing the positive electrode active material. It is considered that, as a result, a change in the crystal structure resulting from charging and discharging could be suppressed and the expansion of the crystal resulting from charging and discharging could be suppressed. Therefore, it is considered that the expansion of the positive electrode substrate resulting from charging and discharging could be suppressed and the nickel coating layer did not suffer a crack or delamination.

From the foregoing, it can be said that each of the alkaline storage batteries according to Examples 10 and 11 is excellent in high-rate discharge characteristic and also excellent in cycle lifetime characteristic. In addition, in each of the alkaline storage batteries according to Examples 10 and 11, the labor of burning off the resin skeleton (non-woven fabric) can be omitted and the average thickness of the nickel coating layer of the positive electrode substrate could also be reduced to 2 μm so that the cost was reduced.

A comparison will further be made between the alkaline storage batteries according to Examples 10 and 11. Although the two batteries are the same in that β-CoOOH was contained in each of the nickel positive electrodes thereof, they are different in the forms in which β-CoOOH was contained and otherwise the same. Specifically, the surface of the positive electrode active material (nickel hydroxide particles) was coated with β-CoOOH in Example 11, while the powder of β-CoOOH was simply mixed with the positive electrode active material (nickel hydroxide particles) and caused to be contained in the nickel positive electrode in Example 10.

As a result of making a comparison between the cycle lifetime characteristic values of the alkaline storage batteries according to Examples 10 and 11, Example 11 showed a higher cycle lifetime characteristic value (85.8%) than Example 10 (84.4%). That is, in the alkaline storage battery according to Example 11, the cycle lifetime characteristic more excellent than in the alkaline storage battery according to Example 10 could be obtained. This is conceivably because, by coating the surface of the positive electrode active material (nickel hydroxide particles) with β-CoOOH, β-CoOOH could be uniformly distributed within the nickel positive electrode and the current collectivity of the nickel positive electrode could further be improved.

### Example 12

In Example 12, five types of nickel-coated resin substrates in which the average thicknesses of the nickel coating layers were different were produced in Step 1 by varying the composition concentrations of nickel plating solutions and the immersion times for the sulfonated non-woven fabric. For the five types of nickel-coated resin substrates, the average thicknesses of the nickel coating layers were examined to be 0.45 μm, 0.50 μm, 2.00 μm, 5.00 μm, and 5.50 μm. In Example 12 also, the proportion of the nickel coating layer to the entire substrate was adjusted for each of the nickel-coated resin substrates to a range of not less than 30 wt % and not more than 80 wt %.

Then, five types of nickel positive electrodes were produced in the same manner as in Steps 2 to 4 of Example 10. In Example 12 also, the theoretical capacity of each of the positive electrodes was assumed to be 1300 mAh in the same manner as in Example 10. Thereafter, five types of cylindrical closed nickel-metal hydride storage batteries each of the AA size were produced in the same manner as in Step 5 of Example 10.

(Evaluation of Battery Characteristics)

Characteristic evaluation was performed with respect to each of the five types of alkaline storage batteries according to Example 12.

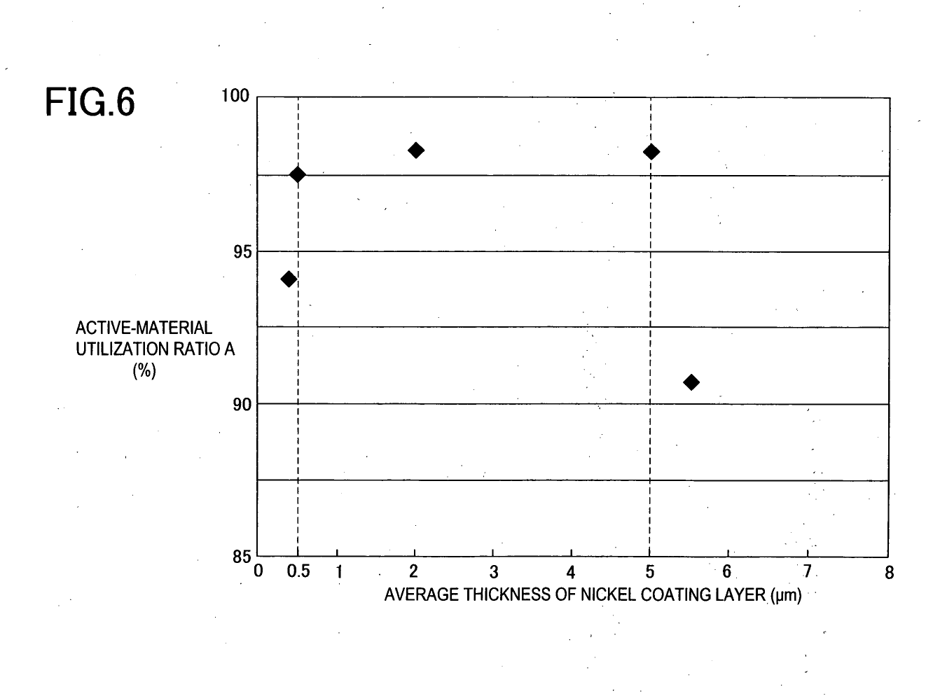

First, an initial charge/discharge cycle test was performed with respect to each of the five types of alkaline storage batteries in the same manner as in Example 10. Then, the active-material utilization ratio A (utilization ratio during 1 C discharge) was calculated for each of the five types of alkaline storage batteries. The results are shown by the marks ♦ in FIG. 6. As shown in FIG. 6, in the batteries in which the average thicknesses of the nickel coating layers were adjusted to 0.50 μm, 2.00 μm, and 5.00 μm, the active-material utilization ratio A became 97% or more (specifically, 97.5%, 98.5%, and 98.5% in this order) so that the excellent charge/discharge efficiencies were obtainable. By contrast, in the battery in which the average thickness of the nickel coating layer was adjusted to 0.45 μm, the active-material utilization ratio A became 94.1% so that the charge/discharge efficiency was slightly inferior. In the battery in which the average thickness of the nickel coating layer was adjusted to 5.50 μm, the active-material utilization ratio was 91.0%, which was the lowest.

After the initial charge/discharge cycle test, each of the batteries was disassembled and the SEM image of the cross section of each of the nickel positive electrodes was observed with the result that, in the battery in which the average thickness was adjusted to 5.50 μm, a crack had occurred in the nickel coating layer. This may be a conceivable cause of the lowered current collectivity of the nickel positive electrode and the lowered active-material utilization ratio A. In the battery in which the average thickness of the nickel coating layer was adjusted to 0.45 μm, on the other hand, a sufficient current collectivity could not be obtained conceivably because the nickel coating layer was extremely thinned so that the charge/discharge efficiency was slightly inferior.

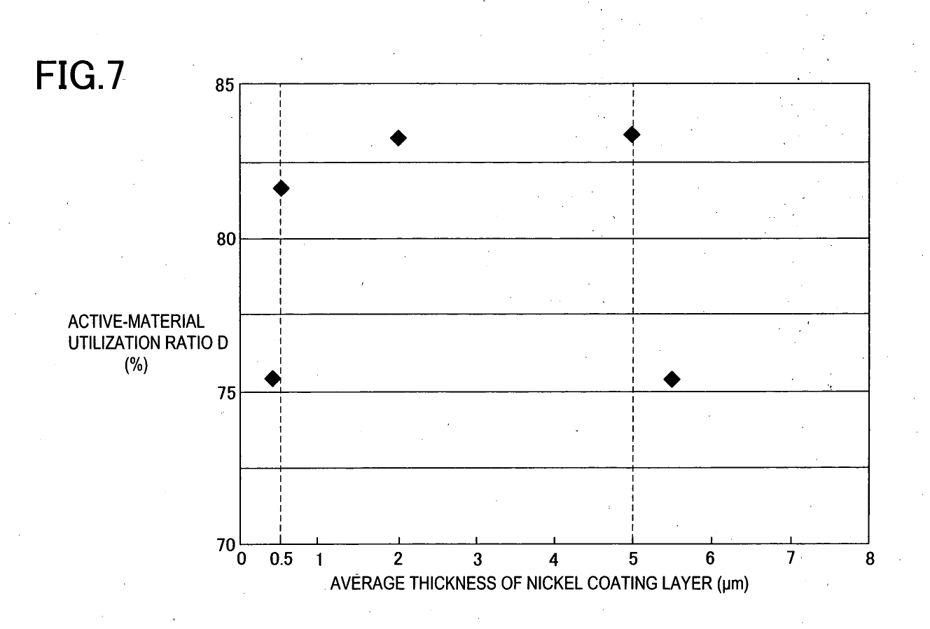

Next, a 1000-cycle long-term charge/discharge cycle test was performed with respect to each of the five types of alkaline storage batteries in the same manner as in Example 10. Then, the active-material utilization ratio D (active-material utilization ratio after 1000 cycles) was calculated for each of the five types of alkaline storage batteries. The results are shown by the marks ♦ in FIG. 7. As shown in FIG. 7, in the battery in which the average thickness of the nickel coating layer was adjusted to 0.45 μm, the active-material utilization ratio D lowered to 75.4%. In the battery in which the average thickness of the nickel coating layer was adjusted to 5.50 μm, the active-material utilization ratio D further lowered to 75.3%.

By contrast, in the batteries in which the average thicknesses of the nickel coating layers were adjusted to 0.50 μm, 2.00 μm, and 5.00 μm, the active-material utilization ratios D after 1000 cycles lowered from the active-material utilization ratios A after initial charging and discharging but still showed high values over 81% (specifically, 81.7%, 83.1%, and 83.2% in this order). From the result, it can be said that, by adjusting the average thickness of the nickel coating layer of the positive electrode substrate to a value of not less than 0.5 μm and not more than 5 μm, an excellent charge/discharge efficiency can be retained over a long period of time. It can also be said that the charge/discharge efficiency which had been held excellent over a long period of time indicates that the current collectivity of the positive electrode (positive electrode substrate) of the battery had been held excellent over a long period of time. Hence, it can be said that, by adjusting the average thickness of the nickel coating layer of the positive electrode substrate to a value of not less than 0.5 μm and not more than 5 μm, the current collectivity of the positive electrode substrate can be held excellent over a long period of time.

### Example 13

In Example 13, seven types of nickel positive electrodes which are different from the nickel positive electrode according to Example 10 only in the contents of metal cobalt were produced in Step 4 by varying the amounts of metal cobalt added thereto. Specifically, the metal cobalt powder was contained at ratios of 1 part by weight, 1.5 parts by weight, 2 parts by weight, 4 parts by weight, 7 parts by weight, 10 parts by weight, and 11 parts by weight to 100 parts by weight of the positive electrode active material (hereinafter the part or parts by weight of metal cobalt relative to 100 parts by weight of the positive electrode active material will be also termed simply as the part or parts by weight). Seven types of cylindrical closed nickel-metal hydride storage batteries each of the AA size (each with a theoretical capacity of 1300 mAh) were produced in otherwise the same manner as in Example 10.

(Evaluation of Battery Characteristics)

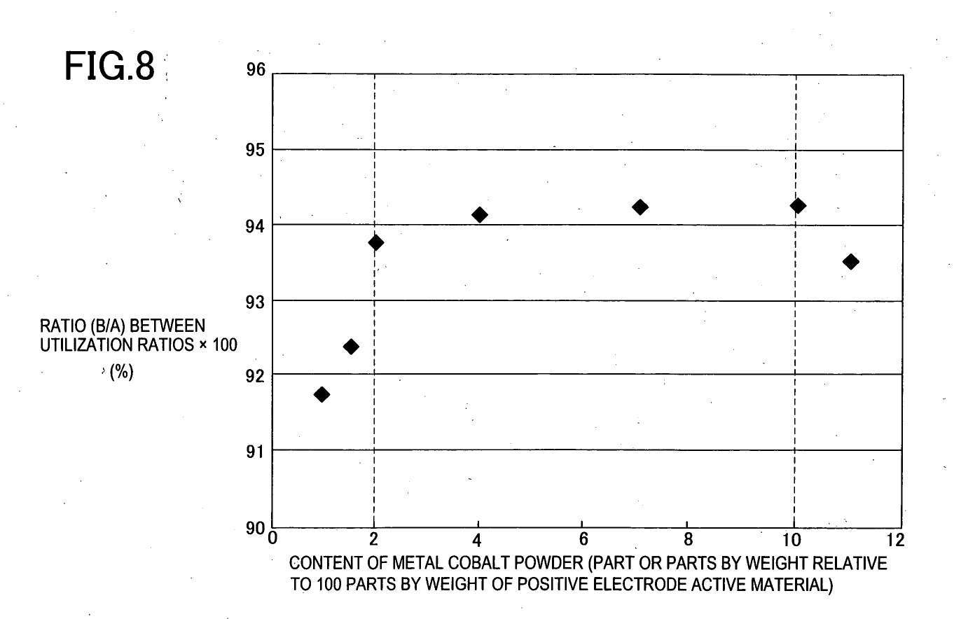

A charge/discharge cycle test was performed with respect to each of the seven types of alkaline storage batteries according to Example 13 in the same manner as in Example 10. Then, the active-material utilization ratios A and B were calculated for each of the seven types of alkaline storage batteries. Then, as an index showing the high-rate discharge characteristic of each of the batteries, the ratio (B/A) of the active-material utilization ratio B to the active-material utilization ratio A×100(%) was calculated. The results are shown by the marks ♦ in FIG. 8.

As shown in FIG. 8, each of the seven types of alkaline storage batteries showed a value (high-rate discharge characteristic value) of the ratio (B/A) between utilization ratios×100(%) which was higher than 90% so that each of them was excellent in high-rate discharge characteristic. As a result of making a detailed examination on the relationship between the contents of the metal cobalt powder and the value of the ratio (B/A) between utilization ratios×100(%), it was found that the high-rate discharge characteristic value greatly differed depending on whether it was under or over 2 parts by weight as a boundary value.

Specifically, as shown in FIG. 8, in the two types of batteries in which the contents of the metal cobalt powder were less than 2 parts by weight (specifically, 1 part by weight and 1.5 parts by weight), the values of the ratios (B/A) between utilization ratios×100(%) were about 92% (specifically, 91.7% and 92.3%). By contrast, in the five types of batteries in which the contents of the metal cobalt powder were not less than 2 parts by weight, the values of the ratios (B/A) between utilization ratios×100(%) were about 94% (specifically, 93.8%, 94.1%, 94.2%, 94.2%, and 93.6%) and higher by about 2% than in the batteries in which the values of the ratios (B/A) between utilization ratios×100(%) were less than 2 parts by weight.

From the foregoing, it can be said that, by adjusting the content of the metal cobalt powder to a value of not less than 2 parts by weight, an excellent high-rate discharge characteristic can be obtained. This is conceivably because, by causing the nickel positive electrode to contain metal cobalt at a ratio of not less than 2 parts by weight to 100 parts by weight of the positive electrode active material, an excellent current collectivity can be obtained.

Of the five types batteries of each of which the high-rate discharge characteristic was excellent, each of the four types of batteries in which the metal cobalt powder was contained in amounts of not more than 10 parts by weight was allowed to have a relatively large battery capacity (theoretical capacity of the positive electrode) of about 1300 mAh. By contrast, the battery in which the metal cobalt powder was contained in an amount of 11 parts by weight had a small battery capacity (theoretical capacity of the positive electrode) of 1100 mAh. This is because, as the content of metal cobalt is increased, the filling amount of the positive electrode active material lowers and the capacity density of the positive electrode lowers accordingly. From the result, it can be said that, by adjusting the content of metal cobalt to a ratio of not more than 10 parts by weight to 100 parts by weight of the positive electrode active material, a relatively large battery capacity (theoretical capacity of the positive electrode) can be provided.

From the result, it can be said that the amount of metal cobalt to be contained in the nickel positive electrode is preferably adjusted to a ratio of 2 to 10 parts by weight to 100 parts by weight of the positive electrode active material.

### Example 14

In Example 14, seven types of nickel positive electrodes which are different from the nickel positive electrode according to Example 10 only in the contents of β-CoOOH were produced in Step 4 by varying the amounts of β-CoOOH added thereto. Specifically, the β-CoOOH powder was contained at ratios of 1 part by weight, 1.5 parts by weight, 2 parts by weight, 4 parts by weight, 7 parts by weight, 10 parts by weight, and 11 parts by weight to 100 parts by weight of the positive electrode active material (hereinafter the part or parts by weight of β-CoOOH relative to 100 parts by weight of the positive electrode active material will be also termed simply as the part or parts by weight). Seven types of cylindrical closed nickel-metal hydride storage batteries each of the AA size were produced in otherwise the same manner as in Example 10.

(Evaluation of Battery Characteristics)

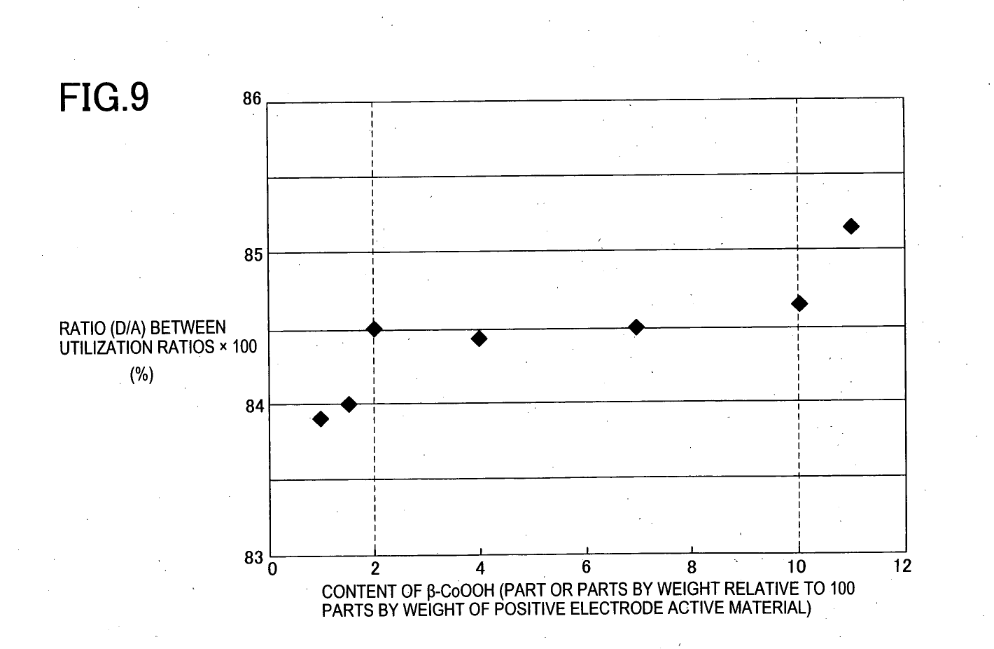

A charge/discharge cycle test was performed with respect to each of the seven types of alkaline storage batteries according to Example 14 in the same manner as in Example 10. Then, the active-material utilization ratios A and D were calculated for each of the seven types of alkaline storage batteries. Then, as an index showing the cycle lifetime characteristic of each of the batteries, the ratio (D/A) of the active-material utilization ratio D to the active-material utilization ratio A×100(%) was calculated. The results are shown by the marks ♦ in FIG. 9. As shown in FIG. 9, in the five types of batteries in which the amounts of contained β-CoOOH were adjusted to be not less than 2 parts by weight, the values of the ratios (D/A) between utilization ratios×100(%) were 84.5%, 84.4%, 84.5%, 84.7%, and 85.2% so that each of them showed an excellent cycle lifetime characteristic.

By contrast, in the two types of batteries in which the contents of β-CoOOH were adjusted to be less than 2 parts by weight (specifically, 1 part by weight and 1.5 parts by weight), the values of the ratios (D/A) between utilization ratios×100(%) became 84% or less and were lower than in the five types of batteries in which the contents of β-CoOOH were adjusted to be not less than 2 parts by weight. It can also be seen from FIG. 9 that, when the content of β-CoOOH is under 2 parts by weight, the value of the ratios (d/A) between utilization ratios×100(%) tends to suddenly lower. From the result, it can be said that, by adjusting the content of β-CoOOH to a value of not less than 2 parts by weight, the cycle lifetime characteristic can be improved. This is conceivably because, by causing the nickel positive electrode to contain β-CoOOH at a ratio of not less than 2 parts by weight to 100 parts by weight of the positive electrode active material in addition to metal cobalt, the oxygen overvoltage during charging could be increased desirably. It is considered that the arrangement preferably allowed the suppression of the oxygen generating reaction during charging and also desirably allowed the suppression of the corrosion (passivation by oxidation) of nickel.

Of the five types batteries of each of which the cycle lifetime characteristic was excellent, each of the four types of batteries in which the β-CoOOH powder was contained in amounts of not more than 10 parts by weight was allowed to have a relatively large battery capacity (theoretical capacity of the positive electrode) of about 1300 mAh. By contrast, the battery in which the β-CoOOH powder was contained in an amount of 11 parts by weight had a small battery capacity (theoretical capacity of the positive electrode) of 1100 mAh. This is because, as the content of β-CoOOH is increased, the filling amount of the positive electrode active material lowers and the capacity density of the positive electrode lowers accordingly. From the result, it can be said that, by adjusting the content of β-CoOOH to a ratio of not more than 10 parts by weight to 100 parts by weight of the positive electrode active material, a relatively large battery capacity (theoretical capacity of the positive electrode) can be provided.

From the result, it can be said that the amount of β-CoOOH to be contained in the nickel positive electrode is preferably adjusted to a ratio of 2 to 10 parts by weight to 100 parts by weight of the positive electrode active material.

### Example 15

In Example 15, the average valence of cobalt contained in β-CoOOH was varied by adjusting an amount of air supplied to the aqueous solution in the reaction vessel (i.e., adjusting the concentration of oxygen in the aqueous solution in the reaction vessel) in Step 3. Specifically, five types of β-CoOOH having different average valences of cobalt such that they were 2.5, 2.6, 2.8, 3.0, and 3.1 were produced. Five types of alkaline storage batteries in which only the average valences of cobalt contained in β-CoOOH were different were produced in otherwise exactly the same manner as in Example 10.

(Evaluation of Battery Characteristics)

A charge/discharge cycle test was performed with respect to each of the five types of alkaline storage batteries according to Example 15 in the same manner as in Example 10. Then, the active-material utilization ratios A, B, and D were calculated for each of the five types of alkaline storage batteries. The results of calculation are shown in Table 3.

TABLE 3

| Average | Active-Material | Active-Material | Active-Material |
|---|---|---|---|
| Valence | Utilization Ratio | Utilization Ratio | Utilization Ratio |
| of Cobalt | A (%) | B (%) | D (%) |
| 2.5 | 97.4 | 90 or More | 80.9 |
| 2.6 | 97 or More | | 82 or More |
| 2.8 | | | |
| 3.0 | | | |
| 3.1 | 96.5 | 88.4 | |

Based on the values of the active-material utilization ratios A, B, and D, the ratios (B/A) between utilization ratios×100(%) were calculated as indices showing the high-rate discharge characteristics and the ratios (D/A) between utilization ratios×100(%) were calculated as indices showing the cycle lifetime characteristics. The results of calculation are shown in Table 4.

TABLE 4

| | High-Rate Discharge | Cycle Lifetime |
|---|---|---|
| Average Valence | Characteristic | Characteristic |
| of Cobalt | (B/A) × 100% | (D/A) × 100% |
| 2.5 | 93 or More | 83.1 |
| 2.6 | | 84 or More |
| 2.8 | | |
| 3.0 | | |
| 3.1 | 91.6 | |

As a result of examining the active-material utilization ratios A, it was found that, as shown in Table 3, the active-material utilization ratio A showed a high value (96.5 or more) in each of the batteries, but the value of the active-material utilization ratio A tended to lower as the average valence of cobalt contained in β-CoOOH increased.

As a result of making comparisons among the values of the active-material utilization ratios B, the active-material utilization ratios B showed a value of not less than 90% in each of the four types of batteries in which the average valences of cobalt contained in β-CoOOH were adjusted to values of not more than 3.0 (specifically, 2.5, 2.6, 2.8, and 3.0) so that excellent active-material utilization ratios were obtainable even during high-rate discharging. By contrast, in the battery in which the average valence of cobalt was adjusted to a value larger than 3.0 (specifically, 3.1), the active-material utilization ratio B had an excellent value of 88.4% but the charge/discharge efficiency during high-rate discharging was slightly inferior to that of each of the other four batteries.

As a result of making comparisons among the values of the ratios (B/A) between utilization ratios×100(%), a values of not less than 93% was shown in each of the four types of batteries in which the average valences of cobalt contained in β-CoOOH were adjusted to a value of not more than 3.0 so that each of the four types of batteries was excellent in high-rate discharge characteristic, as shown in Table 4. By contrast, in the battery in which the average valence of cobalt was adjusted to a value larger than 3.0 (specifically, 3.1), the value of the ratio (B/A) between utilization ratios×100(%) was 91.6% so that the battery was excellent in high-rate discharge characteristic but slightly inferior to the other four types of batteries.

This is conceivably because, when the average valence of cobalt is larger than 3.0, the balance of charges in a cobalt oxyhydroxide crystal is disturbed so that a transition from a β-type crystal structure to a γ-type crystal structure is more likely to occur. Since cobalt oxyhydroxide having a γ-type crystal structure has high oxidizing power (is readily reducible), it undesirably oxidizes metal cobalt contained in the positive electrode. It is considered that the formation of a conductive network inside the positive electrode was prevented thereby and, in particular, the active-material utilization ratio during high-rate discharging lowered.

As a result of subsequently examining the values of the active-material utilization ratios D, the active-material utilization ratio D showed a value higher than 80% in each of the batteries and the active-material utilization ratio was also excellent even after a long-term charge/discharge cycle test as long as 100 cycles, as shown in Table 3. As a result of making a detailed examination, the active-material utilization ratios D were not less than 82% in the four types of batteries in which the average valances of cobalt were adjusted to values of not less than 2.6 (specifically, 2.6, 2.8, 3.0, and 3.1), while the active-material utilization ratio D was 80.9% in the battery in which the average valence of cobalt was adjusted to a value less than 2.6 (specifically, 2.5). Thus, in the batteries in each of which the average valence of cobalt was adjusted to a value of not less than 2.6, the active-material utilization ratio D was more excellent than in the battery in which the average valence of cobalt was adjusted to a value less than 2.6.

As shown in Table 4, the value (cycle lifetime characteristic value) of the ratio (D/A) between utilization ratios×100(%) showed a value higher than 80% in each of the batteries so that each of the batteries was excellent in cycle lifetime characteristic. As a result of making a detailed examination, the cycle lifetime characteristic value was not less than 84% in each of the four types of batteries in which the average valences of cobalt were adjusted to values of not less than 2.6, while the cycle lifetime characteristic value was 83.1% in the battery in which the average valence of cobalt was adjusted to a value less than 2.6. Thus, the batteries in each of which the average valence of cobalt was adjusted to a value not less than 2.6 were more excellent in cycle lifetime characteristic than in the battery in which the average valence of cobalt was adjusted to a value less than 2.6.

This is conceivably because, by adjusting the average valence of cobalt contained in β-CoOOH to a value of not less than 2.6, the oxygen overvoltage during charging can be greatly increased. It is considered that the arrangement allowed the suppression of corrosion (passivation by oxidation) of nickel contained in the positive electrode over a long period of time and consequently allowed an improvement in the cycle lifetime characteristic of the battery.

From the result, it can be said that the average valence of cobalt contained in β-CoOOH in the nickel positive electrode is preferably adjusted to a value of not less than 2.6 and not more than 3.0.

Although the present invention has been described in accordance with Examples 1 to 15, the present invention is not limited to the examples described above and the like. It will easily be appreciated that the present invention can be appropriately modified and applied without departing from the gist thereof.

For example, although the nickel coating layer was formed on the resin skeleton (foamed polypropylene, non-woven fabric) by an electroless plating method in each of Examples 1 to 15, the nickel coating layer may also be formed on the resin skeleton (foamed polypropylene, non-woven fabric) by an electric plating method or a vapor deposition method or by a combination of two or more of electroless plating, electric plating, and vapor deposition methods. Even when any method was used, the result equal to that obtained in each of Examples 1 to 15 were obtainable. The method for forming the nickel coating layer on the resin skeleton is not limited to the three types of the electroless plating, electric plating, and vapor deposition methods. It is also possible to use a proper method as necessary.

Although the foamed resin (specifically, foamed polypropylene) was used as the resin skeleton in each of Examples 1 to 9, a non-woven fabric or woven fabric may also be used instead. Specifically, a nickel-coated resin substrate (positive electrode substrate) was produced by using a non-woven fabric or woven fabric having an average pore diameter of not less than 20 μm and not more than 100 μm and plating the non-woven fabric or woven-fabric with nickel by an electroless plating method. As the non-woven fabric or woven fabric, a fabric composed of polypropylene fibers each having a diameter of 10 to 30 μm was used. Even when the positive electrode substrate having such a resin skeleton was used, the result equal to that obtained in each of Examples 1 to 9 was obtainable. The resin skeleton was not limited to a foamed resin, a non-woven fabric, and a woven fabric. Any resin can be used appropriately as the resin skeleton of the positive electrode substrate provided that it has a three-dimensional network structure and a void portion in which a plurality of pores are coupled in three dimensions.

Although the non-woven fabric was used as the resin skeleton in each of Examples 10 to 15, a woven fabric or a foamed resin may also be used instead. A nickel-coated resin substrate (positive electrode substrate) was actually produced by using a foamed resin or woven fabric having an average pore diameter of not less than 20 μm and not more than 100 μm and plating the formed resin or woven fabric with nickel by an electroless plating method. Even when the positive electrode substrate having such a resin skeleton was used, the same result as obtained in each of Examples 10 to 15 was obtainable. The resin skeleton is not limited to a foamed resin, a non-woven fabric, and a woven fabric. Any resin can be used appropriately as the resin skeleton of the positive electrode substrate provided that it has a three-dimensional network structure and a void portion in which a plurality of pores are coupled in three dimensions.

In each of Examples 1 to 9, polypropylene was used as the resin forming the resin skeleton. In each of Examples 10 to 15, polypropylene and polyethylene were used as the resins forming the resin skeleton. However, the result equal to that obtained in each of Examples 1 to 15 was obtainable by using, as the resin forming the resin skeleton, at least one resin selected from polypropylene, polyethylene, polyvinyl alcohol, polyester, nylon, polymethyl pentene, polystyrene, and polytetrafluoroethylene. Since these resins are excellent in alkali resistance, even when the resin skeleton is exposed, they are free from the influence of the alkaline electrolyte and therefore can be used appropriately. Accordingly, if a positive electrode substrate is produced such that the resin skeleton is not exposed, even a resin not excellent in alkali resistance can be used for the resin skeleton.

The resin skeleton may be formed from either only one resin or a mixture of two or more resins (e.g., a non-woven fabric may be produced from two or more different types of fibers).

Although the nickel-coated resin substrate was produced by using the resin skeleton with an average pore diameter of 350 μm and the average pore diameter of the positive electrode substrate was adjusted to 160 μm after rolling in each of Examples 1 to 9, the positive electrode substrate is not limited to the one with an average pore diameter of 160 μm. Although the nickel-coated resin substrate was produced by using the resin skeleton with an average pore diameter of 60 μm and the average pore diameter of the positive electrode substrate was adjusted to 30 μm after rolling in each of Examples 10 to 15, the positive electrode substrate was not limited to the one with an average pore diameter of 30 μm. A plurality of types of positive electrode substrates with different average pore diameters were actually prepared and the active-material utilization ratios of the batteries using the positive electrode substrates after an initial charge/discharge cycle test were calculated in the same manner as in Example 1. As a result, the active-material utilization ratio (active-material utilization ratio A, charge/discharge efficiency) was higher as the average pore diameter of the positive electrode substrate was smaller.

This is conceivably because, as the diameters of the pores forming the void portion of the positive electrode substrate are smaller, the positive electrode active material and the nickel coating layer are closer and the contact area therebetween is larger so that the current collectivity is improved and the charge/discharge efficiency (utilization ratio of the active material) of the battery is improved. Conversely, it is considered that, as the diameters of the pores forming the void portion of the positive electrode substrate are increased, the current collectivity lowers and the charge/discharge efficiency (utilization ratio of the active material) of the battery lowers. In an actual battery with an average pore diameter or 450 μm or less, the active-material utilization ratio (active-material utilization ratio A) showed a value of not less than 90% so that the charge/discharge efficiency was relatively excellent. By contrast, in an actual battery with an average pore diameter more than 450 μm (specifically, with an average pore diameter of 470 μm), the active-material utilization ratio (active-material utilization ratio A) was as low as 80% so that the charge/discharge efficiency was not preferable.

To improve the charge/discharge efficiency of the battery, the average pore diameter of the positive electrode substrate is preferably minimized. However, because the average particle diameter of the positive electrode active material (nickel hydroxide particles) was about 10 μm, it was difficult to adjust the average pore diameter of the positive electrode substrate to 15 μm or less.

From the foregoing, it can be said that the average diameter of the plurality of pores forming the void portion of the positive electrode substrate is preferably adjusted to be not less than 15 μm and not more than 450 μm.

In each of Examples 1 to 15, the positive electrode active material was produced by using the nickel hydroxide particles each containing magnesium in a solid solution state. However, the element to be contained in the nickel hydroxide particles is not limited only to magnesium. Even in the case where, e.g., zinc was contained in a solid solution state therein, the same effect was obtainable. By causing both of magnesium and zinc to be contained in a solid solution state in a crystal of nickel hydroxide, the expansion of the positive electrode active material could be suppressed more effectively and the expansion of the positive electrode substrate could be suppressed more effectively. It is also possible to cause an element (e.g., cobalt) other than magnesium and zinc to be contained in a solid solution state in the crystal of nickel hydroxide.

In each of Examples 1 to 15, a nickel-metal hydride storage battery using a hydrogen absorbing alloy in the negative electrode thereof was produced. However, in accordance with the present invention, the same effect can also be obtained from any alkaline storage battery such as a nickel-zinc storage battery or a nickel-cadmium storage battery.

In each of Examples 1 to 15, the alkaline storage battery was formed to have a cylindrical configuration but the alkaline storage battery is not limited to such a configuration. The present invention is also applicable to an alkaline storage battery having any configuration such as an angular battery in which the layers of electrode plates are stacked in a case.

In each of the alkaline storage batteries according to Examples 5 to 9, an excellent charge efficiency could be obtained even in a high-temperature state by causing the nickel positive electrode to contain yttrium oxide and zinc oxide. Specifically, as a result of evaluating the charge characteristic at a high temperature based on the active-material utilization ratio when, after the discharge capacity of each of the batteries was stabilized, the battery was charged with a current of 1 C at 60° C. for 1.2 hours and then discharged to release a current of 1 C till the battery voltage became 0.8 V, an excellent result was obtained. This is conceivably because, by causing the nickel positive electrode to contain yttrium oxide and zinc oxide, the oxygen overvoltage could be increased and the oxygen generating reaction during the final period of charging could be suppressed even in a high temperature state (60° C.).

In each of the alkaline storage batteries according to Examples 5 to 15, the nickel positive electrode was caused to contain yttrium oxide and zinc oxide. However, it is also possible to cause the nickel positive electrode to contain either one of yttrium oxide and zinc oxide. Since the oxygen overvoltage can be increased by causing the nickel positive electrode to contain at least either of yttrium oxide and zinc oxide, it was recognized that, even in a high temperature state, the oxygen generating reaction during the final period of charging could be suppressed and the high-temperature charge efficiency could be improved. However, a more excellent high-temperature charge efficiency was obtainable by causing both of yttrium oxide and zinc oxide to be contained than by causing either one of them.

Although the proportion of the nickel coating layer to the positive electrode substrate was adjusted to 60 wt % in each of the alkaline storage batteries according to Examples 5 to 9, the proportion of the nickel coating layer is not limited to such a value. Likewise, although the proportion of the nickel coating layer to the positive electrode substrate was adjusted to 55 wt % in each of the alkaline storage batteries according to Examples 10 to 15, the proportion of the nickel coating layer is not limited to such a value, either. As a result of actually adjusting the proportion of the nickel coating layer to the positive electrode substrate to the range of 27 to 84 wt % and examining the active-material utilization ratios A and C for each of the alkaline storage batteries according to Examples 5 to 15, an excellent result was obtainable in the range of 30 to 80 wt %. From the result, it can be said that, by adjusting the proportion of the nickel coating layer to the positive electrode substrate to a value of not less than 30 wt % and not more than 80 wt %, the current collectivity of the positive electrode can be held excellent over a long period of time.

1. A positive electrode for an alkaline storage battery, the positive electrode comprising:
a positive electrode substrate comprising a resin skeleton made of a resin and having a three-dimensional network structure and a nickel coating layer made of nickel and coating the resin skeleton, the positive electrode substrate having a void portion in which a plurality of pores are coupled in three dimensions; and
a positive electrode active material containing nickel hydroxide particles and filled in the void portion of the positive electrode substrate, wherein
an average thickness of the nickel coating layer is not less than 0.5 μm and not more than 5 μm,
a proportion of the nickel coating layer to the positive electrode substrate is not less than 30 wt % and not more than 80 wt %, and
a filling amount of the positive electrode active material is not less than 3 times and not more than 10 times a weight of the positive electrode substrate.

2. The positive electrode for an alkaline storage battery according to claim 1, wherein the resin skeleton is any of a foamed resin, a non-woven fabric, and a woven fabric.

3. The positive electrode for an alkaline storage battery according to claim 1, wherein the resin skeleton is made of at least one resin selected from the group consisting of polypropylene, polyethylene, polyvinyl alcohol, polyester, nylon, polymethyl pentene, polystyrene, and polytetrafluoroethylene.

4. The positive electrode for an alkaline storage battery according to claim 1, wherein an average pore diameter of the plurality of pores forming the void portion of the positive electrode substrate is not less than 15 μm and not more than 450 μm.

5. The positive electrode for an alkaline storage battery according to claim 1, wherein the positive electrode active material contains at least either of zinc and magnesium in a solid solution state in each of the nickel hydroxide particles.

6. The positive electrode for an alkaline storage battery according to claim 1, wherein the nickel coating layer is formed on a surface of the resin skeleton by any of an electroplating method, an electroless plating method, and a vapor deposition method.

7. An alkaline storage battery having a positive electrode for an alkaline storage battery according to claim 1.

8. A positive electrode for an alkaline storage battery, the positive electrode comprising:
a positive electrode substrate comprising a resin skeleton made of a resin and having a three-dimensional network structure and a nickel coating layer made of nickel and coating the resin skeleton, the positive electrode substrate having a void portion in which a plurality of pores are coupled in three dimensions; and
a positive electrode active material containing nickel hydroxide particles and filled in the void portion of the positive electrode substrate, wherein
an average thickness of the nickel coating layer is not less than 0.5 μm and not more than 5 μm and
in addition to the positive electrode active material, at least either of metal cobalt and cobalt oxyhydroxide having a γ-type crystal structure is contained in the void portion of the positive electrode substrate.

9. The positive electrode for an alkaline storage battery according to claim 8, wherein a proportion of the nickel coating layer to the positive electrode substrate is not less than 30 wt % and not more than 80 wt %.

10. The positive electrode for an alkaline storage battery according to claim 8, wherein the resin skeleton is any of a foamed resin, a non-woven fabric, and a woven fabric.

11. The positive electrode for an alkaline storage battery according to claim 8, wherein the resin skeleton is made of at least one resin selected from the group consisting of polypropylene, polyethylene, polyvinyl alcohol, polyester, nylon, polymethyl pentene, polystyrene, and polytetrafluoroethylene.

12. The positive electrode for an alkaline storage battery according to claim 8, wherein at least either of the metal cobalt and the cobalt oxyhydroxide having a γ-type crystal structure is contained at a ratio of 2 to 10 parts by weight to 100 parts by weight of the positive electrode active material.

13. The positive electrode for an alkaline storage battery according to claim 8, wherein a surface of the positive electrode active material is coated with the cobalt oxyhydroxide having a γ-type crystal structure.

14. The positive electrode for an alkaline storage battery according to claim 8, wherein the positive electrode active material contains at least either of zinc and magnesium in a solid solution state in each of the nickel hydroxide particles.

15. The positive electrode for an alkaline storage battery according to claim 8, wherein, in addition to the positive electrode active material, at least either of yttrium oxide and zinc oxide is contained in the void portion of the positive electrode substrate.

16. The positive electrode for an alkaline storage battery according to claim 8, wherein the nickel coating layer is formed on a surface of the resin skeleton by any of an electroplating method, an electroless plating method, and a vapor deposition method.

17. An alkaline storage battery having a positive electrode for an alkaline storage battery according to claim 8.

18. A positive electrode for an alkaline storage battery, the positive electrode comprising:
a positive electrode substrate comprising a resin skeleton made of a resin and having a three-dimensional network structure and a nickel coating layer made of nickel and coating the resin skeleton, the positive electrode substrate having a void portion in which a plurality of pores are coupled in three dimensions; and
a positive electrode active material containing nickel hydroxide particles and filled in the void portion of the positive electrode substrate, wherein
an average thickness of the nickel coating layer is not less than 0.5 μm and not more than 5 μm and
in addition to the positive electrode active material, at least either of metal cobalt and cobalt oxyhydroxide having a β-type crystal structure is contained in the void portion of the positive electrode substrate.

19. The positive electrode for an alkaline storage battery according to claim 18, wherein a proportion of the nickel coating layer to the positive electrode substrate is not less than 30 wt % and not more than 80 wt %.

20. The positive electrode for an alkaline storage battery according to claim 18, wherein the resin skeleton is any of a foamed resin, a non-woven fabric, and a woven fabric.

21. The positive electrode for an alkaline storage battery according to claim 20, wherein the resin skeleton is a non-woven fabric.

22. The positive electrode for an alkaline storage battery according to claim 18, wherein the resin skeleton is made of at least one resin selected from the group consisting of polypropylene, polyethylene, polyvinyl alcohol, polyester, nylon, polymethyl pentene, polystyrene, and polytetrafluoroethylene.

23. The positive electrode for an alkaline storage battery according to claim 18, wherein the metal cobalt is contained at a ratio of 2 to 10 parts by weight to 100 parts by weight of the positive electrode active material.

24. The positive electrode for an alkaline storage battery according to claim 18, wherein the cobalt oxyhydroxide having a β-type crystal structure is contained at a ratio of 2 to 10 parts by weight to 100 parts by weight of the positive electrode active material.

25. The positive electrode for an alkaline storage battery according to claim 18, wherein a surface of the positive electrode active material is coated with the cobalt oxyhydroxide having a β-type crystal structure.

26. The positive electrode for an alkaline storage battery according to claim 18, wherein an average valence of cobalt contained in the cobalt oxyhydroxide having a β-type crystal structure is not less than 2.6 and not more than 3.0.

27. The positive electrode for an alkaline storage battery according to claim 18, wherein the positive electrode active material contains at least either of zinc and magnesium in a solid solution state in each of the nickel hydroxide particles.

28. The positive electrode for an alkaline storage battery according to claim 18, wherein, in addition to the positive electrode active material, at least either of yttrium oxide and zinc oxide is contained in the void portion of the positive electrode substrate.

29. The positive electrode for an alkaline storage battery according to claim 18, wherein the nickel coating layer is formed on a surface of the resin skeleton by any of an electroplating method, an electroless plating method, and a vapor deposition method.

30. An alkaline storage battery having a positive electrode for an alkaline storage battery according to claim 18.
